(19) United States
(12) Patent Application Publication
(10) Pub. No.: US 2026/0175942 A1
(43) Pub. Date: Jun. 25, 2026

(54) 3-77 Oimatsu-cho, Sakai-ku

(71) Applicant: Shimano Inc., Osaka (JP)

(72) Inventors: Satoshi SHAHANA, Osaka (JP); Takehiko NAKAJIMA, Osaka (JP); Shota NISHIJIMA, Osaka (JP); Hayato SHIMAZU, Osaka (JP)

(21) Appl. No.: 19/385,607

(22) Filed: Nov. 11, 2025

(30) Foreign Application Priority Data
Dec. 24, 2024 (JP) 2024-227406

(51) Int. Cl. B62M 25/08; B62J 45/415

(52) U.S. Cl. CPC B62M 25/08; B62J 45/415

(57) ABSTRACT

A control device for a human-powered vehicle includes an electronic controller configured to control a transmission device for shifting a transmission ratio that is a ratio of a rotational speed of a wheel to a rotational speed of a crank axle. In a case where the electronic controller controls the transmission device to decrease the transmission ratio based on a first shifting condition, the electronic controller controls the transmission device so that the transmission ratio does not become less than a first transmission ratio that is greater than a minimum transmission ratio. In a case where the electronic controller controls the transmission device to decrease the transmission ratio based on a second shifting condition, the electronic controller controls the transmission device so that the transmission ratio does not become less than a second transmission ratio that is greater than the first transmission ratio.

### CROSS-REFERENCE TO RELATED APPLICATIONS

This application claims priority to Japanese Patent Application No. 2024-227406, filed on December 24, 2024. The entire disclosure of Japanese Patent Application No. 2024-227406 is hereby incorporated herein by reference.

### BACKGROUND

### Technical Field

The present disclosure generally relates to a control device for a human-powered vehicle.

### Background Information

Japanese Laid-Open Patent Publication No. 2013-47085 discloses an example of a control device for a human-powered vehicle that controls a transmission device of the human-powered vehicle.

### SUMMARY OF THE DISCLOSURE

An objective of the present disclosure is to provide a control device for a human-powered vehicle that controls a transmission device in a preferred manner.

A control device in accordance with a first aspect of the present disclosure is for a human-powered vehicle. The control device comprises an electronic controller configured to control a transmission device for shifting a transmission ratio that is a ratio of a rotational speed of a wheel of the human-powered vehicle to a rotational speed of a crank axle of the human-powered vehicle. The electronic controller is configured to control the transmission device to shift the transmission ratio based on one of a plurality of shifting conditions. The shifting conditions include a first shifting condition and a second shifting condition differing from the first shifting condition. In a case where the electronic controller controls the transmission device to decrease the transmission ratio based on the first shifting condition, the electronic controller is configured to control the transmission device so that the transmission ratio does not become less than a first transmission ratio that is greater than a minimum transmission ratio. The minimum transmission ratio is a smallest transmission ratio to which the transmission device can be shifted. In a case where the electronic controller controls the transmission device to decrease the transmission ratio based on the second shifting condition, the electronic controller is configured to control the transmission device so that the transmission ratio does not become less than a second transmission ratio that is greater than the first transmission ratio.

The control device according to the first aspect controls the transmission device so that the transmission ratio does not become less than the first transmission ratio under the first shifting condition, and so that the transmission ratio does not become less than the second transmission ratio under the second shifting condition. In this manner, the transmission device is appropriately controlled in accordance with the selected shifting condition.

In accordance with a second aspect of the present disclosure, the control device according to the first aspect is configured so that the first shifting condition includes a first threshold value related to a predetermined parameter. The second shifting condition includes a second threshold value related to the predetermined parameter and differing from the first threshold value. In a case where the electronic controller controls the transmission device to shift the transmission ratio based on the first shifting condition, the electronic controller is configured to control the transmission device to decrease the transmission ratio where the predetermined parameter crosses the first threshold value and so that the transmission ratio does not become less than the first transmission ratio. In a case where the electronic controller controls the transmission device to shift the transmission ratio based on the second shifting condition, the electronic controller is configured to control the transmission device to decrease the transmission ratio where the predetermined parameter crosses the second threshold value and so that the transmission ratio does not become less than the second transmission ratio.

With the control device according to the second aspect, in a case where the transmission device is controlled based on the first shifting condition and the predetermined parameter crosses the first threshold value, the transmission ratio does not become less than the first transmission ratio. With the control device according to the second aspect, in a case where the transmission device is controlled based on the second shifting condition and the predetermined parameter crosses the second threshold value, the transmission ratio does not become less than the second transmission ratio.

In accordance with a third aspect of the present disclosure, the control device according to the second aspect is configured so that the second threshold value is less than the first threshold value. In a case where the electronic controller controls the transmission device to shift the transmission ratio based on the first shifting condition, the electronic controller is configured to control the transmission device to decrease the transmission ratio where the predetermined parameter becomes less than the first threshold value and so that the transmission ratio does not become less than the first transmission ratio. In a case where the electronic controller controls the transmission device to shift the transmission ratio based on the second shifting condition, the electronic controller is configured to control the transmission device to decrease the transmission ratio where the predetermined parameter becomes less than the second threshold value and so that the transmission ratio does not become less than the second transmission ratio.

With the control device according to the third aspect, in a case where the transmission device is controlled based on the first shifting condition and the predetermined parameter becomes less than the first threshold value, the transmission ratio does not become less than the first transmission ratio. With the control device according to the third aspect, in a case where the transmission device is controlled based on the second shifting condition and the predetermined parameter becomes less than the second threshold value, the transmission ratio does not become less than the second transmission ratio.

A control device in accordance with a fourth aspect of the present disclosure is for a human-powered vehicle. The control device comprises an electronic controller configured to control a transmission device for shifting a transmission ratio that is a ratio of a rotational speed of a wheel of the human-powered vehicle to a rotational speed of a crank axle of the human-powered vehicle. The electronic controller is configured to control the transmission device to shift the transmission ratio based on a shifting condition. In a case where the electronic controller controls the transmission device to decrease the transmission ratio based on the shifting condition and where a traveling state of the human-powered vehicle is a first traveling state, the electronic controller is configured to control the transmission device so that the transmission ratio does not become less than a third transmission ratio. In a case where the electronic controller controls the transmission device to decrease the transmission ratio based on the shifting condition and where the traveling state of the human-powered vehicle is a second traveling state differing from the first traveling state, the electronic controller is configured to control the transmission device so that the transmission ratio does not become less than a fourth transmission ratio that is greater than the third transmission ratio.

The control device according to the fourth aspect controls the transmission device so that the transmission ratio does not become less than the third transmission ratio in the first traveling state, and so that the transmission ratio does not become less than the fourth transmission ratio in the second traveling state. In this manner, the transmission device is appropriately controlled in accordance with the traveling state.

In accordance with a fifth aspect of the present disclosure, the control device according to the fourth aspect is configured so that the first traveling state is greater than the second traveling state in at least one of a gradient of a road on which the human-powered vehicle is traveling, a change rate of the gradient, a vibration level of the human-powered vehicle, and a change rate of the vibration level.

The control device according to the fifth aspect selects one of the third transmission ratio and the fourth transmission ratio in accordance with at least one of the gradient of the road on which the human-powered vehicle is traveling, the change rate of the gradient, the vibration level of the human-powered vehicle, and the change rate of vibration level.

In accordance with a sixth aspect of the present disclosure, the control device according to the fifth aspect is configured so that the electronic controller is configured to select one of the third transmission ratio and the fourth transmission ratio in accordance with an output of an inclination detector provided on the human-powered vehicle.

The control device according to the sixth aspect appropriately selects one of the third transmission ratio and the fourth transmission ratio in accordance with the output of the inclination detector.

In accordance with a seventh aspect of the present disclosure, the control device according to the fourth aspect is configured so that the first traveling state includes a state in which the human-powered vehicle is traveling off-road. The second traveling state includes a state in which the human-powered vehicle is traveling on-road.

The control device according to the seventh aspect selects the third transmission ratio in a state in which the human-powered vehicle is traveling off-road, and selects the fourth transmission ratio in a state in which the human-powered vehicle is traveling on-road.

In accordance with an eighth aspect of the present disclosure, the control device according to the seventh aspect is configured so that the electronic controller is configured to select one of the third transmission ratio and the fourth transmission ratio based on positional information of the human-powered vehicle.

The control device according to the eighth aspect appropriately selects one of the third transmission ratio and the fourth transmission ratio based on the positional information of the human-powered vehicle.

In accordance with a ninth aspect of the present disclosure, the control device according to any one of the fourth to eighth aspects is configured so that the shifting condition includes a threshold value related to a predetermined parameter. In a case where the electronic controller controls the transmission device to shift the transmission ratio based on the shifting condition, the electronic controller is configured to control the transmission device to decrease the transmission ratio where the predetermined parameter crosses the threshold value.

The control device according to the ninth aspect decreases the transmission ratio in a case where the predetermined parameter crosses the threshold value.

In accordance with a tenth aspect of the present disclosure, the control device according to the ninth aspect is configured so that in a case where the electronic controller controls the transmission device to shift the transmission ratio based on the shifting condition, the electronic controller is configured to control the transmission device to decrease the transmission ratio where the predetermined parameter becomes less than the threshold value.

The control device according to the tenth aspect decreases the transmission ratio in a case where the predetermined parameter becomes less than the threshold value.

A control device in accordance with an eleventh aspect of the present disclosure is for a human-powered vehicle. The control device comprises an electronic controller configured to control a transmission device for shifting a transmission ratio that is a ratio of a rotational speed of a wheel of the human-powered vehicle to a rotational speed of a crank axle of the human-powered vehicle. The electronic controller is configured to control the transmission device to shift the transmission ratio based on a shifting condition. In a case where the electronic controller controls the transmission device to decrease the transmission ratio based on the shifting condition and where a setting state of a drive unit configured to apply propulsion force to the human-powered vehicle is a first setting state, the electronic controller is configured to control the transmission device so that the transmission ratio does not become less than a fifth transmission ratio. In a case where the electronic controller controls the transmission device to decrease the transmission ratio based on the shifting condition and where the setting state is a second setting state differing from the first setting state, the electronic controller is configured to control the transmission device so that the transmission ratio does not become less than a sixth transmission ratio that is greater than the fifth transmission ratio.

The control device according to the eleventh aspect controls the transmission device so that the transmission ratio does not become less than the fifth transmission ratio in the first setting state, and so that the transmission ratio does not become less than the sixth transmission ratio in the second setting state. In this manner, the transmission device is appropriately controlled in accordance with the setting state.

In accordance with a twelfth aspect of the present disclosure, the control device according to the eleventh aspect is configured so that the setting state includes a state related to an output level of the drive unit. The output level in the first setting state is greater than the output level in the second setting state.

The control device according to the twelfth aspect appropriately selects one of the fifth transmission ratio and the sixth transmission ratio in accordance with the output level.

In accordance with a thirteenth aspect of the present disclosure, the control device according to the eleventh or twelfth aspect is configured so that the human-powered vehicle further includes an operating unit with which a user changes the setting state. The electronic controller is configured to acquire the setting state from at least one of the operating unit and the drive unit.

The control device according to the thirteenth aspect appropriately acquires the setting information from at least one of the operating unit and the drive unit.

In accordance with a fourteenth aspect of the present disclosure, the control device according to the eleventh or twelfth aspect is configured so that the drive unit is configured to change the setting state based on a traveling state of the human-powered vehicle. The electronic controller is configured to acquire the setting state from the drive unit.

The control device according to the fourteenth aspect appropriately selects one of the fifth transmission ratio and the sixth transmission ratio in accordance with the setting state, changed by the drive unit based on the traveling state of the human-powered vehicle.

In accordance with a fifteenth aspect of the present disclosure, the control device according to any one of the eleventh to fourteenth aspects is configured so that the shifting condition includes a threshold value related to a predetermined parameter. In a case where the electronic controller controls the transmission device to shift the transmission ratio based on the shifting condition, the electronic controller is configured to control the transmission device to decrease the transmission ratio where the predetermined parameter crosses the threshold value.

The control device according to the fifteenth aspect decreases the transmission ratio in a case where the predetermined parameter crosses the threshold value.

In accordance with a sixteenth aspect of the present disclosure, the control device according to the fifteenth aspect is configured so that in a case where the electronic controller controls the transmission device to shift the transmission ratio based on the shifting condition, the electronic controller is configured to control the transmission device to decrease the transmission ratio where the predetermined parameter becomes less than the threshold value.

The control device according to the sixteenth aspect decreases the transmission ratio in a case where the predetermined parameter becomes less than the threshold value.

In accordance with a seventeenth aspect of the present disclosure, the control device according to any one of the second, third, ninth, tenth, fifteenth, and sixteenth aspects is configured so that the predetermined parameter is related to the rotational speed of the crank axle.

The control device according to the seventeenth aspect appropriately shifts the transmission ratio based on the rotational speed of the crank axle.

In accordance with an eighteenth aspect of the present disclosure, the control device according to any one of the second, third, ninth, tenth, fifteenth, sixteenth, and seventeenth aspects is configured so that the predetermined parameter is related to a human driving force applied to the crank axle.

The control device according to the eighteenth aspect appropriately shifts the transmission ratio based on the human driving force.

The human-powered vehicle control device according to the present disclosure controls the transmission device in a preferred manner.

### BRIEF DESCRIPTION OF THE DRAWINGS

Referring now to the attached drawings which form a part of this original disclosure, illustrative embodiments are shown.

FIG. 1 is a side elevational view of a human-powered vehicle including a human-powered vehicle control device in accordance with a first embodiment.

FIG. 2 is a block diagram showing the electrical configuration of the human-powered vehicle shown in FIG. 1.

FIG. 3 is a flowchart illustrating a control process executed by an electronic controller shown in FIG. 2 to control a transmission device.

FIG. 4 is a block diagram showing the electrical configuration of a human-powered vehicle in accordance with a second embodiment.

FIG. 5 is a flowchart illustrating a control process executed by an electronic controller shown in FIG. 4 to control a transmission device.

FIG. 6 is a block diagram showing the electrical configuration of a human-powered vehicle in accordance with a third embodiment.

FIG. 7 is a flowchart illustrating a control process executed by an electronic controller shown in FIG. 6 to control a transmission device.

### DETAILED DESCRIPTION

Selected embodiments will now be explained with reference to the drawings. It will be apparent to those skilled in the human-powered vehicle field from this disclosure that the following descriptions of the embodiments are provided for illustration only and not for the purpose of limiting the invention as defined by the appended claims and their equivalents.

### First Embodiment

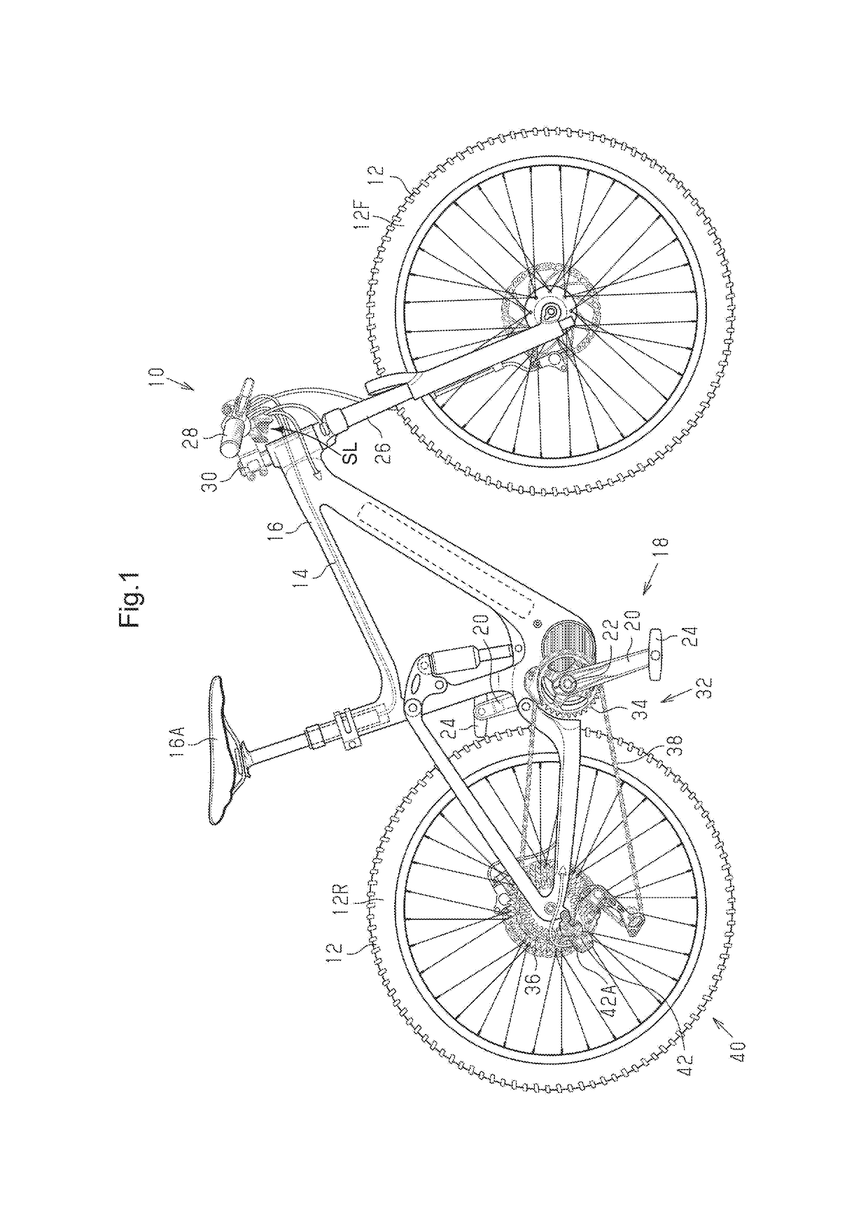

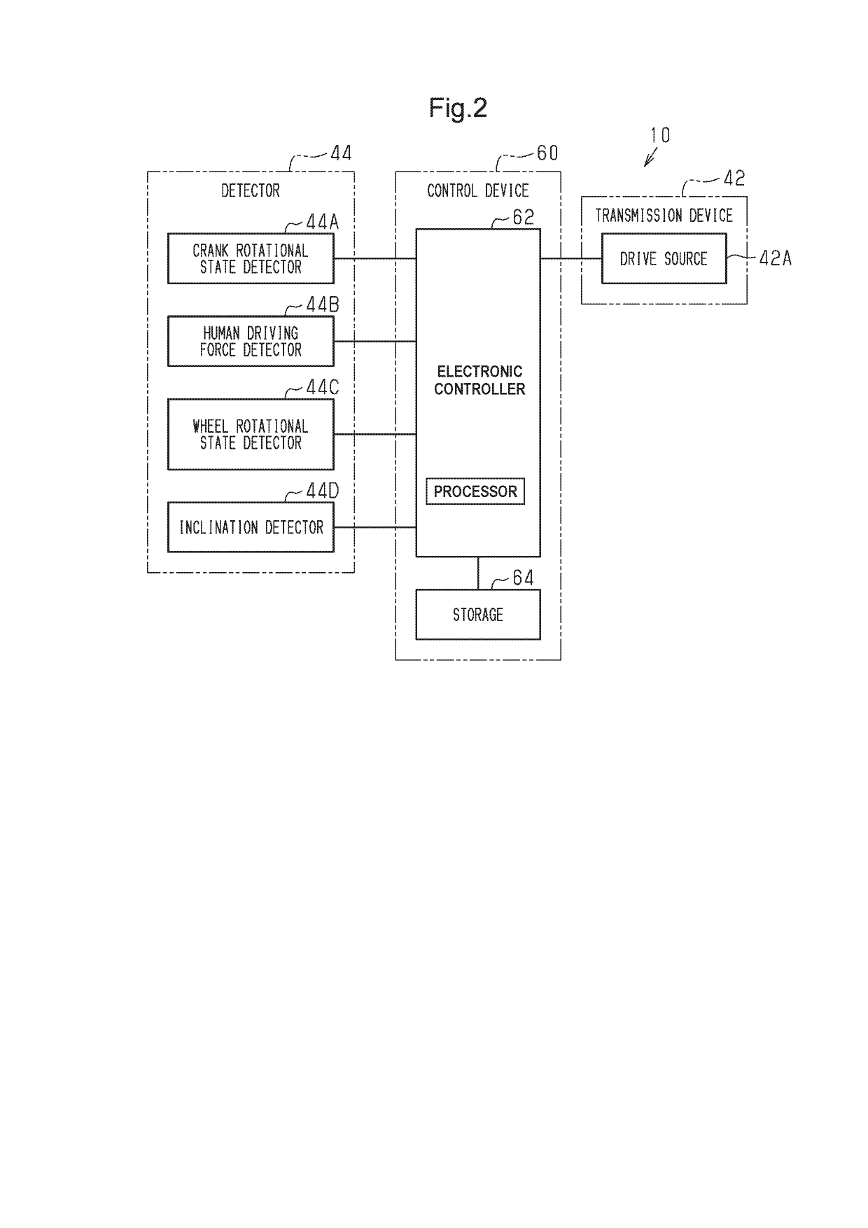

A human-powered vehicle 10 including a human-powered vehicle control device 60 in accordance with a first embodiment will now be described with reference to FIGS. 1 to 3. The human-powered vehicle 10 is a vehicle that includes at least one wheel and can be driven by at least a human driving force. Examples of the human-powered vehicle include various types of bicycles, such as a mountain bike, a road bike, a city bike, a cargo bike, a handcycle, a recumbent bike, and the like. There is no limit to the number of wheels of the human-powered vehicle 10 . The human-powered vehicle 10 also includes, for example, a unicycle or a vehicle having two or more wheels. The human-powered vehicle 10 is not limited to a vehicle that can be driven only by a human driving force. The human-powered vehicle 10 includes an electric bicycle (E-bike) that uses a driving force of an electric motor for propulsion in addition to a human driving force. The E-bike includes an electric assist bicycle that assists in propulsion with an electric motor. In each embodiment described hereafter, the human-powered vehicle 10 refers to a bicycle.

In the illustrated embodiments, the human-powered vehicle 10 includes at least one wheel 12 and a vehicle body 14. The at least one wheel 12 includes, for example, a front wheel 12F and a rear wheel 12R. The vehicle body 14 includes a frame 16. For example, a saddle 16A is attached to the frame 16.

The human-powered vehicle 10 further includes, for example, a crank 18 that receives a human driving force. The crank 18 includes, for example, a crank arm 20 and a crank axle 22. The crank axle 22 is, for example, rotatable relative to the frame 16. For example, a pedal 24 is coupled to the crank arm 20. The crank arm 20 is, for example, provided on each axial end of the crank axle 22.

A front fork 26 is connected to the frame 16. The front wheel 12F is attached to the front fork 26. A handlebar 28 is coupled to the front fork 26 by a stem 30. The rear wheel 12R is supported by the frame 16. In the present embodiment, the crank 18 is connected to the rear wheel 12R by a drive mechanism 32. The rear wheel 12R is driven by rotation of the crank axle 22. At least one of the front wheel 12F and the rear wheel 12R can be connected to the crank 18 by the drive mechanism 32.

The drive mechanism 32 includes at least one first rotational body 34 coupled to the crank axle 22. The at least one first rotational body 34 includes, for example, a front sprocket. The at least one first rotational body 34 can include a pulley or a bevel gear. The crank axle 22 can be coupled to the front sprocket by a one-way clutch.

The drive mechanism 32 further includes at least one second rotational body 36 and a transferring member 38. The transferring member 38 is configured to transfer rotational force of the at least one first rotational body 34 to the at least one second rotational body 36. The transferring member 38 includes, for example, a chain. The transferring member 38 can include a belt or a shaft. The at least one second rotational body 36 includes, for example, a rear sprocket. The at least one second rotational body 36 can include a pulley or a bevel gear. The chain is, for example, wound around the front sprocket and the rear sprocket. The at least one second rotational body 36 is, for example, coupled to the rear wheel 12R. The rear wheel 12R is, for example, configured to rotate as the at least one second rotational body 36 rotates.

The human-powered vehicle 10 includes, for example, at least part of a human-powered vehicle control system 40. The control system 40 includes, for example, the human-powered vehicle control device 60 and a transmission device 42.

The transmission device 42 shifts a transmission ratio that is a ratio of a rotational speed of the wheel 12 of the human-powered vehicle 10 to a rotational speed of the crank axle 22 of the human-powered vehicle 10. The transmission device 42 is, for example, configured to shift the transmission ratio in stages. The transmission device 42 is configured to shift the transmission ratio of the human-powered vehicle 10 in accordance with a transmission stage. The transmission ratio of the human-powered vehicle 10 is, for example, a ratio of a rotational speed of the rear wheel 12R to a rotational speed of the crank axle 22. The transmission device 42 is, for example, provided on the frame 16. The transmission device 42 includes, for example, at least one of a rear transmission device and a front transmission device. The transmission device 42 includes, for example, an external transmission device. The transmission device 42 includes, for example, a rear derailleur. The transmission device 42 can include a front derailleur. The transmission device 42 can include an internal transmission device. The internal transmission device is, for example, provided in a hub of the rear wheel 12R. The transmission device 42 can include a continuously variable transmission (CVT). The transmission device 42 can also be more simply referred to as a transmission or vehicle transmission.

The transmission device 42 includes, for example, an electric transmission device. The transmission device 42 includes, for example, a drive source 42A actuated by electric power. Actuation of the drive source 42A shifts the transmission ratio. The drive source 42A includes, for example, an electric motor.

The human-powered vehicle control device 60 includes an electronic controller 62. The terms “controller” and “electronic controller” as used herein refer to hardware that executes a software program, and does not include a human being. Generally speaking, the electronic controller 62 is formed of one or more semiconductor chips that are mounted on a circuit board. The electronic controller 62 includes, for example, a processor that executes predetermined control programs. The processor of the electronic controller 62 includes, for example, a central processing unit (CPU) or a micro-processing unit (MPU). The CPU or MPU of the electronic controller 62 can be one or more integrated circuits having firmware for causing the circuitry to execute the predetermined control programs and/or complete the activities described herein, The processor of the electronic controller 62 can be provided at separate locations. In a case where the processor is provided at separate locations, different parts of the processor can be connected to one another in a manner allowing for communication via a wireless communication device. The electronic controller 62 can include one or more microcomputers.

The control device 60 further includes, for example, storage 64. The storage 64 can also be referred to as memory or a computer storage device. The storage 64 is, for example, connected to the electronic controller 62 in a manner allowing for wired or wireless communication. The storage 64 stores, for example, control programs and information (e.g., settings, calculations and/or results) used for control processes. The storage 64 includes, for example, non-volatile memory and volatile memory. The non-volatile memory includes, for example, at least one of read-only memory (ROM), erasable programmable read-only memory (EPROM), electrically erasable programmable read-only memory (EEPROM), and flash memory. The volatile memory includes, for example, random access memory (RAM).

The electronic controller 62 is configured to control the transmission device 42. The electronic controller 62 is configured to control the transmission device 42 to shift the transmission ratio based on one of a plurality of shifting conditions. In addition to the shifting conditions, the electronic controller 62 can be configured to control the transmission device 42 to shift transmission ratio in response to, for example, a shifting signal. The shifting signal is, for example, output from a shift operator (e.g., see a shifter SL in FIG. 1) operated by a user.

The shifting condition includes, for example, a threshold value related to a predetermined parameter. The predetermined parameter is related to, for example, at least one of a traveling state of the human-powered vehicle 10 and a traveling environment of the human-powered vehicle 10. The predetermined parameter is related to, for example, the rotational speed of the crank axle 22. The predetermined parameter is related to, for example, the human driving force applied to the crank axle 22. The predetermined parameter can be related to a rotational state of the wheel 12. The rotational state of the wheel 12 includes, for example, at least one of the rotational speed of the wheel 12 and the vehicle speed. The predetermined parameter can be related to an inclination angle of the human-powered vehicle 10. The predetermined parameter can include two or more of the rotational speed of the crank axle 22, the human driving force applied to the crank axle 22, the rotational state of the wheel 12, and the inclination angle of the human-powered vehicle 10.

The control system 40 further includes, for example, a detector 44 for detecting the predetermined parameter. The detector 44 includes, for example, at least one of a crank rotational state detector 44A, a human driving force detector 44B, a wheel rotational state detector 44C, and an inclination detector 44D. The term “detector” as used herein refers to a hardware device or instrument designed to detect the presence or absence of a particular event, object, substance, or a change in its environment, and to emit a signal in response. The term “detector” as used herein refers to hardware and does not include a human being.

The crank rotational state detector 44A is, for example, connected to the electronic controller 62 in a manner that allows for wired or wireless communication. The crank rotational state detector 44A is, for example, configured to detect a rotational amount of the crank axle 22 and a rotational amount of the first rotational body 34. The first rotational body 34 includes, for example, a front sprocket or a front pulley. The crank rotational state detector 44A is, for example, configured to detect at least one of information corresponding to the rotational speed of the crank axle 22 and information corresponding to the rotational speed of the first rotational body 34. The information corresponding to the rotational speed of the crank axle 22 includes, for example, angular acceleration of the crank axle 22. The information corresponding to the rotational speed of the first rotational body 34 includes, for example, angular acceleration of the first rotational body 34.

The crank rotational state detector 44A is, for example, configured to output at least one of a signal corresponding to the rotational speed of the crank axle 22 and a signal corresponding to the rotational speed of the first rotational body 34. The crank rotational state detector 44A is, for example, configured to output at least one of a detection signal corresponding to a rotational angle of the crank axle 22 and a detection signal corresponding to a rotational angle of the first rotational body 34 during a period in which the crank axle 22 and the first rotational body 34 complete a single rotation.

The crank rotational state detector 44A includes, for example, a magnetic sensor that outputs a signal corresponding to the strength of a magnetic field. The crank rotational state detector 44A includes, for example, a ring-shaped magnet in which magnetic poles are arranged in the circumferential direction. The ring-shaped magnet is, for example, provided on the crank axle 22. The ring-shaped magnet includes, for example, a single S-pole and a single N-pole. The single S-pole and the single N-pole each extend 180° continuously about a rotational center axis of the crank axle 22 in the circumferential direction. Instead of the magnetic sensor, the crank rotational state detector 44A can include an optical sensor, an acceleration sensor, a gyro sensor, a torque sensor, or the like.

The crank rotational state detector 44A can be configured to detect a rotational amount of the second rotational body 36. The second rotational body 36 includes, for example, a rear sprocket or a rear pulley. The crank rotational state detector 44A can be configured to detect information corresponding to a rotational speed of the second rotational body 36. The information corresponding to the rotational speed of the second rotational body 36 includes, for example, angular acceleration of the second rotational body 36. The crank rotational state detector 44A can be configured to output a signal corresponding to the rotational speed of the second rotational body 36.

The crank rotational state detector 44A can include a vehicle speed sensor. In a case where the crank rotational state detector 44A includes a vehicle speed sensor, the electronic controller 62 can be configured to calculate the rotational speed of the crank axle 22 from the vehicle speed detected by the vehicle speed sensor and the transmission ratio. The crank rotational state detector 44A can include a wheel speed sensor. In a case where the crank rotational state detector 44A includes a wheel speed sensor, the electronic controller 62 can be configured to calculate the rotational speed of the crank axle 22 from the rotational speed of the wheel 12 detected by the wheel speed sensor and the transmission ratio. For example, the wheel speed sensor can have the same configuration as the wheel rotational state detector 44C.

The human driving force detector 44B is, for example, provided on a member included in a transmission path of human driving force, or on a member located in the vicinity of a member that is included in the transmission path of a human driving force. The human driving force detector 44B includes a strain sensor, a magnetostrictive sensor, a pressure sensor, or the like. The strain sensor includes a strain gauge. The human driving force detector 44B can have any configuration as long as information related to human driving force is obtained.

The human driving force detector 44B can be, for example, provided on at least one of the crank arm 20 and the pedal 24. In a case where the human driving force detector 44B is provided on the pedal 24, the human driving force detector 44B can include a sensor that detects pressure applied to the pedal 24. The human driving force detector 44B can be provided on the chain. In a case where the human driving force detector 44B is provided on the chain, the human driving force detector 44B can include a sensor that detects the tension on the chain.

The wheel rotational state detector 44C is, for example, connected to the electronic controller 62 in a manner allowing for wired or wireless communication. The wheel rotational state detector 44C is, for example, configured to detect information related to the speed of the human-powered vehicle 10. The wheel rotational state detector 44C is, for example, configured to detect information related to the rotational speed of the wheel 12. The wheel rotational state detector 44C is, for example, configured to detect a magnet provided on at least one of the front wheel 12F and the rear wheel 12R.

The wheel rotational state detector 44C includes, for example, a vehicle speed sensor. The wheel rotational state detector 44C is, for example, configured to output a predetermined number of detection signals during a period in which the wheel 12 completes a single rotation. The predetermined number is, for example, one. The wheel rotational state detector 44C outputs, for example, a signal corresponding to the rotational speed of the wheel 12. The electronic controller 62 can calculate the speed of the human-powered vehicle 10 based on the signal corresponding to the rotational speed of the wheel 12 and information related to the circumferential length of the wheel 12. The information related to the circumferential length of the wheel 12 is, for example, stored in the storage 64.

The inclination detector 44D includes, for example, an inclination sensor that detects at least one of a pitch angle, a roll angle, and a yaw angle of the human-powered vehicle 10. The inclination sensor includes, for example, at least one of a gyro sensor and an acceleration sensor. The inclination detector 44D is, for example, configured to detect a road gradient corresponding to at least one of the pitch angle, the roll angle, and the yaw angle of the human-powered vehicle 10. The inclination detector 44D can include a global positioning system (GPS) receiver. In a case where the inclination detector 44D includes a GPS receiver, for example, map information including information related to the road gradient is stored in the storage 64 in advance. The electronic controller 62 acquires the road gradient of the present location of the human-powered vehicle 10 from the map information stored in the storage 64.

In a case where the electronic controller 62 controls the transmission device 42 to shift the transmission ratio based on the shifting condition, for example, the electronic controller 62 is configured to control the transmission device 42 to shift the transmission ratio where the predetermined parameter crosses the threshold value. A case where the predetermined parameter crosses any of various types of threshold values corresponds to a case where the predetermined parameter becomes greater than an upper limit threshold value and where the threshold value is the upper limit threshold value. A case where the predetermined parameter crosses any of various types of threshold values corresponds to a case where the predetermined parameter becomes less than a lower limit threshold value and where the threshold value is the lower limit threshold value.

In a case where the electronic controller 62 controls the transmission device 42 to shift the transmission ratio based on the shifting condition, for example, the electronic controller 62 is configured to control the transmission device 42 to decrease the transmission ratio where the predetermined parameter crosses the threshold value. The shifting condition includes, for example, an additional threshold value related to the predetermined parameter. In a case where the electronic controller 62 controls the transmission device 42 to shift the transmission ratio based on the shifting condition, for example, the electronic controller 62 is configured to control the transmission device 42 to increase the transmission ratio where the predetermined parameter crosses the additional threshold value. For example, one of the threshold value and the additional threshold value is a lower limit threshold value, and the other one of the threshold value and the additional threshold value is an upper limit threshold value. The lower limit threshold value is less than the upper limit threshold value.

In a case where the electronic controller 62 controls the transmission device 42 to shift the transmission ratio based on the shifting condition, the electronic controller 62 is configured to control the transmission device 42 in accordance with one of a first shift control example and a second shift control example.

In the first shift control example, in a case where the electronic controller 62 controls the transmission device 42 to shift the transmission ratio based on the shifting condition, for example, the electronic controller 62 is configured to control the transmission device 42 to decrease the transmission ratio where the predetermined parameter becomes less than the threshold value. In a case where the electronic controller 62 controls the transmission device 42 to shift the transmission ratio based on the shifting condition, for example, the electronic controller 62 is configured to control the transmission device 42 to decrease the transmission ratio where the predetermined parameter becomes less than the lower limit threshold value.

In the first shift control example, in a case where the electronic controller 62 controls the transmission device 42 to shift the transmission ratio based on the shifting condition, for example, the electronic controller 62 is configured to control the transmission device 42 to increase the transmission ratio where the predetermined parameter becomes greater than the additional threshold value. In a case where the electronic controller 62 controls the transmission device 42 to shift the transmission ratio based on the shifting condition, for example, the electronic controller 62 is configured to control the transmission device 42 to increase the transmission ratio where the predetermined parameter becomes greater than the upper limit threshold value. In the first shift control example, the threshold value is the lower limit threshold value, and the additional threshold value is the upper limit threshold value.

In the first shift control example, in a case where the predetermined parameter has a negative correlation with the load on the rider, for example, the electronic controller 62 can reduce the load on the rider. In the first shift control example, in a case where the predetermined parameter has a negative correlation with the load on the rider, for example, the electronic controller 62 can restrict increases in the predetermined parameter. In the first shift control example, in a case where the predetermined parameter has a positive correlation with the load on the rider, for example, the electronic controller 62 can increase the transmission ratio in accordance with the intention of the rider to accelerate. The predetermined parameter having a negative correlation with the load on the rider is, for example, the rotational speed of the crank axle 22, the rotational speed of the wheel 12, and the vehicle speed. The predetermined parameter having a positive correlation with the load on the rider is, for example, the human driving force, the pitch angle of the human-powered vehicle 10, and the gradient of the road on which the human-powered vehicle 10 is traveling.

In the second shift control example, in a case where the electronic controller 62 controls the transmission device 42 to shift the transmission ratio based on the shifting condition, for example, the electronic controller 62 is configured to control the transmission device 42 to increase the transmission ratio where the predetermined parameter becomes less than the additional threshold value. In a case where the electronic controller 62 controls the transmission device 42 to shift the transmission ratio based on the shifting condition, for example, the electronic controller 62 is configured to control the transmission device 42 to increase the transmission ratio where the predetermined parameter becomes less than the lower limit threshold value.

In the second shift control example, in a case where the electronic controller 62 controls the transmission device 42 to shift the transmission ratio based on the shifting condition, for example, the electronic controller 62 is configured to control the transmission device 42 to decrease the transmission ratio where the predetermined parameter becomes greater than the threshold value. In a case where the electronic controller 62 controls the transmission device 42 to shift the transmission ratio based on the shifting condition, for example, the electronic controller 62 is configured to control the transmission device 42 to decrease the transmission ratio where the predetermined parameter becomes greater than the upper limit threshold value. In the second shift control example, the threshold value is the upper limit threshold value, and the additional threshold value is the lower limit threshold value.

In the second shift control example, in a case where the predetermined parameter has a positive correlation with the load on the rider, for example, the electronic controller 62 can reduce the load on the rider. In the second shift control example, in a case where the predetermined parameter has a positive correlation with the load on the rider, for example, the electronic controller 62 can restrict increases in the predetermined parameter. In the second shift control example, in a case where the predetermined parameter has a negative correlation with the load on the rider, for example, the electronic controller 62 can decrease the transmission ratio in accordance with the intention of the rider to increase the predetermined parameter under a condition in which the load on the rider is relatively small.

The shifting conditions include a first shifting condition and a second shifting condition differing from the first shifting condition. In a case where the electronic controller 62 controls the transmission device 42 to decrease the transmission ratio based on the first shifting condition, the electronic controller 62 is configured to control the transmission device 42 so that the transmission ratio does not become less than a first transmission ratio that is greater than a minimum transmission ratio. The minimum transmission ratio is the smallest transmission ratio to which the transmission device 42 can be shifted. In a case where the electronic controller 62 controls the transmission device 42 to decrease the transmission ratio based on the second shifting condition, the electronic controller 62 is configured to control the transmission device 42 so that the transmission ratio does not become less than a second transmission ratio that is greater than the first transmission ratio.

The shifting conditions each include the threshold value. The number of shifting conditions can be three or more. For example, the threshold values of the shifting conditions are set to different values. The shifting conditions each include the additional threshold value. For example, the additional threshold values of the shifting conditions can be set to different values. Alternatively, the additional threshold values can be set to the same value. The electronic controller 62 selects one of the shifting conditions, for example, in a case where the rider operates an operating device. The electronic controller 62 determines whether to shift the transmission ratio based on the selected one of the shifting conditions.

The first shifting condition includes, for example, a first threshold value related to the predetermined parameter. The second shifting condition includes, for example, a second threshold value related to the predetermined parameter and differing from the first threshold value. The first shifting condition includes, for example, a first additional threshold value related to the predetermined parameter. The first threshold value includes, for example, a first lower limit threshold value or a first upper limit threshold value. The first lower limit threshold value is less than the first upper limit threshold value. In the first shift control example, the first threshold value is the first lower limit threshold value, and the first additional threshold value is the first upper limit threshold value. In the second shift control example, the first threshold value is the first upper limit threshold value, and the first additional threshold value is the first lower limit threshold value. The second shifting condition includes, for example, a second additional threshold value related to the predetermined parameter. The second threshold value includes, for example, a second lower limit threshold value or a second upper limit threshold value. The second lower limit threshold value is less than the second upper limit threshold value. In the first shift control example, the second threshold value is the second lower limit threshold value, and the second additional threshold value is the second upper limit threshold value. In the second shift control example, the second threshold value is the second upper limit threshold value, and the second additional threshold value is the second lower limit threshold value.

In the first shift control example, for example, the second threshold value is less than the first threshold value. In the first shift control example, the second threshold value can be greater than the first threshold value. In the second shift control example, for example, the second threshold value is greater than the first threshold value. In the second shift control example, for example, the second threshold value can be less than the first threshold value. The second lower limit threshold value is, for example, less than the first lower limit threshold value. The first upper limit threshold value is, for example, less than the second upper limit threshold value. The first upper limit threshold value can be greater than or equal to the second upper limit threshold value. The difference of the first lower limit threshold value and the first upper limit threshold value can be the same as or differ from the difference of the second lower limit threshold value and the second upper limit threshold value.

In a case where the electronic controller 62 controls the transmission device 42 to shift the transmission ratio based on the first shifting condition, for example, the electronic controller 62 is configured to control the transmission device 42 to decrease the transmission ratio where the predetermined parameter crosses the first threshold value and so that the transmission ratio does not become less than the first transmission ratio.

In a case where the electronic controller 62 controls the transmission device 42 to shift the transmission ratio based on the first shifting condition, for example, the electronic controller 62 is configured to control the transmission device 42 to decrease the transmission ratio where the predetermined parameter becomes less than the first threshold value and so that the transmission ratio does not become less than the first transmission ratio. In the first shift control example, in a case where the electronic controller 62 controls the transmission device 42 to shift the transmission ratio based on the first shifting condition, for example, the electronic controller 62 is configured to control the transmission device 42 to decrease the transmission ratio where the predetermined parameter becomes less than the first lower limit threshold value and so that the transmission ratio does not become less than the first transmission ratio. In the second shift control example, in a case where the electronic controller 62 controls the transmission device 42 to shift the transmission ratio based on the first shifting condition, for example, the electronic controller 62 is configured to control the transmission device 42 to decrease the transmission ratio where the predetermined parameter becomes greater than the first upper limit threshold value and so that the transmission ratio does not become less than the first transmission ratio.

In a case where the electronic controller 62 controls the transmission device 42 to shift the transmission ratio based on the second shifting condition, for example, the electronic controller 62 is configured to control the transmission device 42 to decrease the transmission ratio where the predetermined parameter crosses the second threshold value and so that the transmission ratio does not become less than the second transmission ratio. In a case where the electronic controller 62 controls the transmission device 42 to shift the transmission ratio based on the second shifting condition, for example, the electronic controller 62 is configured to control the transmission device 42 to decrease the transmission ratio where the predetermined parameter becomes less than the second threshold value and so that the transmission ratio does not become less than the second transmission ratio. In the first shift control example, in a case where the electronic controller 62 controls the transmission device 42 to shift the transmission ratio based on the second shifting condition, for example, the electronic controller 62 is configured to control the transmission device 42 to decrease the transmission ratio where the predetermined parameter becomes less than the second lower limit threshold value and so that the transmission ratio does not become less than the second transmission ratio. In the second shift control example, in a case where the electronic controller 62 controls the transmission device 42 to shift the transmission ratio based on the second shifting condition, for example, the electronic controller 62 is configured to control the transmission device 42 to decrease the transmission ratio where the predetermined parameter becomes greater than the second upper limit threshold value and so that the transmission ratio does not become less than the second transmission ratio.

In a case where the predetermined parameter is related to the human driving force and the second shift control example is executed, the threshold value of each of the shifting conditions can be set in accordance with a range of the human driving force. In each shifting condition, for example, the threshold value includes a threshold value in a case where the human driving force is less than or equal to a first human driving force, a threshold value in a case where the human driving force is greater than the first human driving force and less than or equal to a second human driving force, and a threshold value in a case where the human driving force is greater than the second human driving force. The threshold value of each of the shifting conditions set in accordance with a range of the human driving force can be associated with a determination time corresponding to the human driving force. For example, the determination time becomes shorter as the human driving force increases. In a case where the electronic controller 62 determines that the human driving force is continuously greater than the threshold value over the determination time associated with the selected threshold value or longer, the electronic controller 62 determines that the shifting condition is satisfied. In a case where the predetermined parameter is related to the human driving force and the second shift control example is executed, the shifting condition does not have to include the additional threshold value.

An example assumes that the predetermined parameter has a negative correlation with the load on the rider, the first shift control example is executed, and the second threshold value is less than the first threshold value. In this example, even if the load on the rider increases in a case where the second shifting condition is selected, the transmission ratio is less likely to be decreased than a case where the first shifting condition is selected. Therefore, in a case where the second shifting condition is selected, the human-powered vehicle 10 is more readily accelerated in accordance with the intention of the rider than a case where the first shifting condition is selected. An example assumes that the predetermined parameter has a negative correlation with the load on the rider, the first shift control example is executed, and the second threshold value is greater than the first threshold value. In this example, if the load on the rider increases in a case where the second shifting condition is selected, the transmission ratio is more likely to be decreased than a case where the first shifting condition is selected. Therefore, in a case where the second shifting condition is selected, increases in the load on the rider are more restricted than a case where the first shifting condition is selected.

An example assumes that the predetermined parameter has a positive correlation with the load on the rider, the first shift control example is executed, and the second threshold value is less than the first threshold value. In this example, even if the load on the rider decreases in a case where the second shifting condition is selected, the transmission ratio is less likely to be decreased than a case where the first shifting condition is selected. Therefore, in a case where the second shifting condition is selected, the human-powered vehicle 10 is less likely to be decelerated than a case where the first shifting condition is selected. An example assumes that the predetermined parameter has a positive correlation with the load on the rider, the first shift control example is executed, and the second threshold value is greater than the first threshold value. In this example, if the load on the rider decreases in a case where the second shifting condition is selected, the transmission ratio is more likely to be decreased than a case where the first shifting condition is selected. Therefore, in a case where the second shifting condition is selected, the rider can increase the human driving force again under a smaller load than a case where the first shifting condition is selected.

An example assumes that the predetermined parameter has a positive correlation with the load on the rider, the second shift control example is executed, and the second threshold value is greater than the first threshold value. In this example, even if the load on the rider increases in a case where the second shifting condition is selected, the transmission ratio is less likely to be decreased than a case where the first shifting condition is selected. Therefore, in a case where the second shifting condition is selected, the human-powered vehicle 10 is more readily accelerated in accordance with the intention of the rider than a case where the first shifting condition is selected. An example assumes that the predetermined parameter has a positive correlation with the load on the rider, the second shift control example is executed, and the second threshold value is less than the first threshold value. In this example, if the load on the rider increases in a case where the second shifting condition is selected, the transmission ratio is more likely to be decreased than a case where the first shifting condition is selected. Therefore, in a case where the second shifting condition is selected, increases in the load on the rider are more restricted than a case where the first shifting condition is selected.

An example assumes that the predetermined parameter has a negative correlation with the load on the rider, the second shift control example is executed, and the second threshold value is greater than the first threshold value. In this example, even if the load on the rider decreases in a case where the second shifting condition is selected, the transmission ratio is less likely to be decreased than a case where the first shifting condition is selected. Therefore, in a case where the second shifting condition is selected, the human-powered vehicle 10 is less likely to be decelerated than a case where the first shifting condition is selected. An example assumes that the predetermined parameter has a negative correlation with the load on the rider, the second shift control example is executed, and the second threshold value is less than the first threshold value. In this example, if the load on the rider decreases in a case where the second shifting condition is selected, the transmission ratio is more likely to be decreased than a case where the first shifting condition is selected. Therefore, in a case where the second shifting condition is selected, the rider can increase the human driving force again under a smaller load than a case where the first shifting condition is selected.

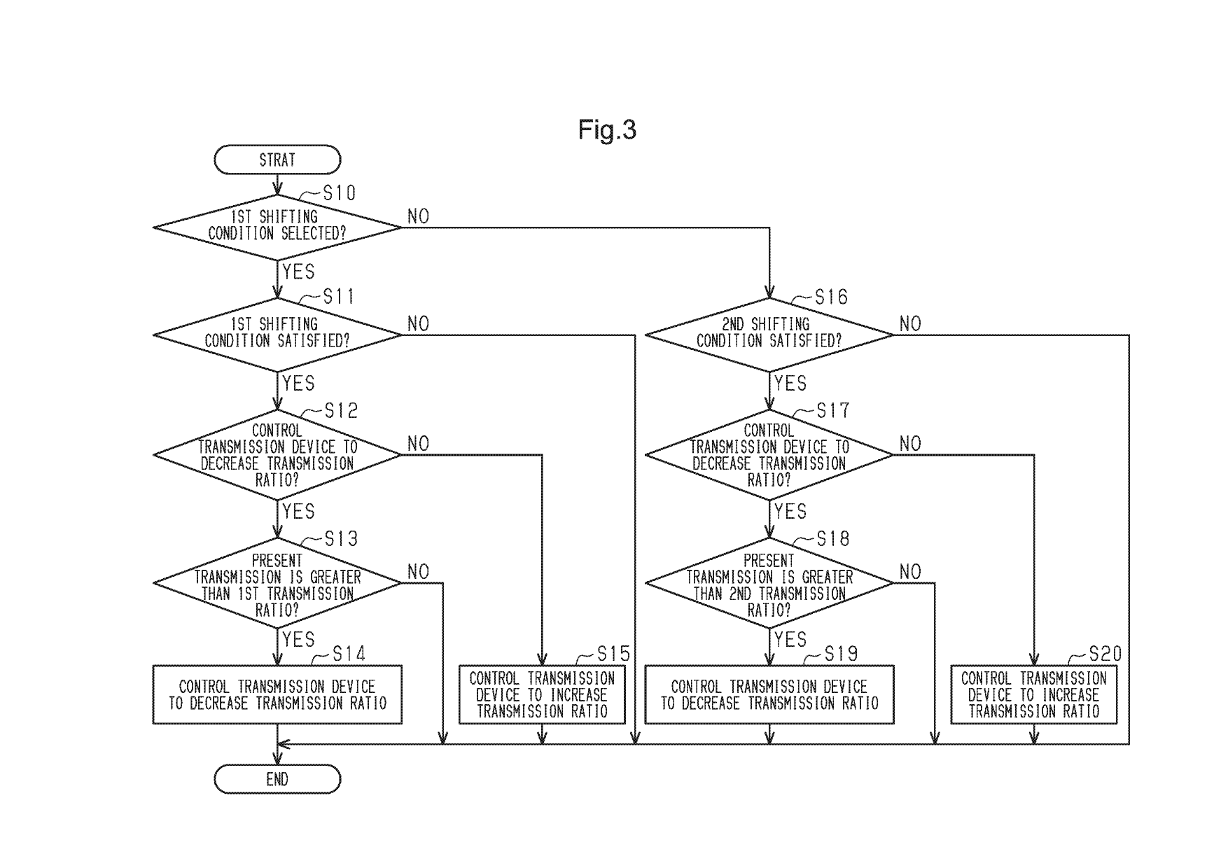

A control process executed by the electronic controller 62 to control the transmission device 42 will now be described with reference to FIG. 3. In a case where electric power is supplied to the electronic controller 62, for example, the electronic controller 62 starts the control process of the flowchart shown in FIG. 3 from step S10. In a case where the control process of the flowchart shown in FIG. 3 ends, for example, the electronic controller 62 repeats the control process from step S10 in predetermined cycles until the supply of electric power is stopped.

In step S10, the electronic controller 62 determines whether the first shifting condition is selected. In a case where the first shifting condition is selected, the electronic controller 62 proceeds to step S11. In step S11, the electronic controller 62 determines whether the first shifting condition is satisfied. The electronic controller 62 determines whether the first shifting condition is satisfied, for example, based on a comparison result of the predetermined parameter and the first threshold value. In a case where the predetermined parameter includes the first lower limit threshold value and the first upper limit threshold value, for example, the electronic controller 62 determines that the first shifting condition is satisfied in either one of a case where the predetermined parameter is less than the first lower limit threshold value and a case where the predetermined parameter is greater than the first upper limit threshold value. In a case where the first shifting condition is satisfied, the electronic controller 62 proceeds to step S12.

In step S12, the electronic controller 62 determines whether to control the transmission device 42 to decrease the transmission ratio. The electronic controller 62 performs the determination in step S12, for example, based on the determination result of the predetermined parameter and the first threshold value in step S11. The electronic controller 62 determines to control the transmission device 42 to decrease the transmission ratio, for example, in a case where the predetermined parameter is less than the first lower limit threshold value. The electronic controller 62 determines not to control the transmission device 42 to decrease the transmission ratio, for example, in a case where the predetermined parameter is greater than the first upper limit threshold value. In a case where the electronic controller 62 controls the transmission device 42 to decrease the transmission ratio, the electronic controller 62 proceeds to step S13.

In step S13, the electronic controller 62 determines whether the present transmission ratio is greater than the first transmission ratio. In a case where the present transmission ratio is greater than the first transmission ratio, the electronic controller 62 proceeds to step S14. In step S14, the electronic controller 62 controls the transmission device 42 to decrease the transmission ratio, and then ends the control process.

In a case where the present transmission ratio is not greater than the first transmission ratio in step S13, the electronic controller 62 ends the control process. In a case where the present transmission ratio is less than or equal to the first transmission ratio in step S13, for example, the electronic controller 62 does not change the transmission ratio from the present transmission ratio.

In a case where the electronic controller 62 determines not to control the transmission device 42 to decrease the transmission ratio in step S12, the electronic controller 62 proceeds to step S15. In step S15, the electronic controller 62 controls the transmission device 42 to increase the transmission ratio, and then ends the control process.

In a case where the first shifting condition is not selected in step S10, the electronic controller 62 proceeds to step S16. In the present embodiment, a case where the first shifting condition is not selected corresponds to a case where the second shifting condition is selected. In step S16, the electronic controller 62 determines whether the second shifting condition is satisfied. The electronic controller 62 determines whether the second shifting condition is satisfied, for example, based on a comparison result of the predetermined parameter and the second threshold value. In a case where the predetermined parameter includes the second lower limit threshold value and the second upper limit threshold value, for example, the electronic controller 62 determines that the second shifting condition is satisfied in either one of a case where the predetermined parameter is less than the second lower limit threshold value and a case where the predetermined parameter is greater than the second upper limit threshold value. In a case where the second shifting condition is satisfied, the electronic controller 62 proceeds to step S17. In a case where the second shifting condition is not satisfied, the electronic controller 62 ends the control process.

In step S17, the electronic controller 62 determines whether to control the transmission device 42 to decrease the transmission ratio. The electronic controller 62 performs the determination in step S17, for example, based on the determination result of the predetermined parameter and the second threshold value in step S16. The electronic controller 62 determines to control the transmission device 42 to decrease the transmission ratio, for example, in a case where the predetermined parameter is less than the second lower limit threshold value. The electronic controller 62 determines not to control the transmission device 42 to decrease the transmission ratio, for example, in a case where the predetermined parameter is greater than the second upper limit threshold value. In a case where the electronic controller 62 controls the transmission device 42 to decrease the transmission ratio, the electronic controller 62 proceeds to step S18.

In step S18, the electronic controller 62 determines whether the present transmission ratio is greater than the second transmission ratio. In a case where the present transmission ratio is greater than the second transmission ratio, the electronic controller 62 proceeds to step S19. In step S19, the electronic controller 62 controls the transmission device 42 to decrease the transmission ratio, and then ends the control process.

In a case where the present transmission ratio is not greater than the second transmission ratio in step S18, the electronic controller 62 ends the control process. In a case where the present transmission ratio is less than or equal to the second transmission ratio in step S18, for example, the electronic controller 62 does not change the transmission ratio from the present transmission ratio.

In a case where the electronic controller 62 determines not to control the transmission device 42 to decrease the transmission ratio in step S17, the electronic controller 62 proceeds to step S20. In step S20, the electronic controller 62 controls the transmission device 42 to increase the transmission ratio, and then ends the control process.

In a case where the shifting condition does not include the additional threshold value, steps S12, S15, S17, and S20 can be omitted. In a case where the shifting condition does not include the additional threshold value and where an affirmative determination is given in step S11, the electronic controller 62 proceeds to step S13. In a case where the shifting condition does not include the additional threshold value and where an affirmative determination is given in step S16, the electronic controller 62 proceeds to step S18.

In a case where the user selects a desired one of the shifting conditions, the electronic controller 62 sets the threshold value to a threshold value desired by the user, so that the transmission ratio does not become less than the lower limit transmission ratio that corresponds to the shifting condition selected by the user. The electronic controller 62 changes both the threshold value and the lower limit transmission ratio in response to a change of the shifting condition. This improves usability.

### Second Embodiment

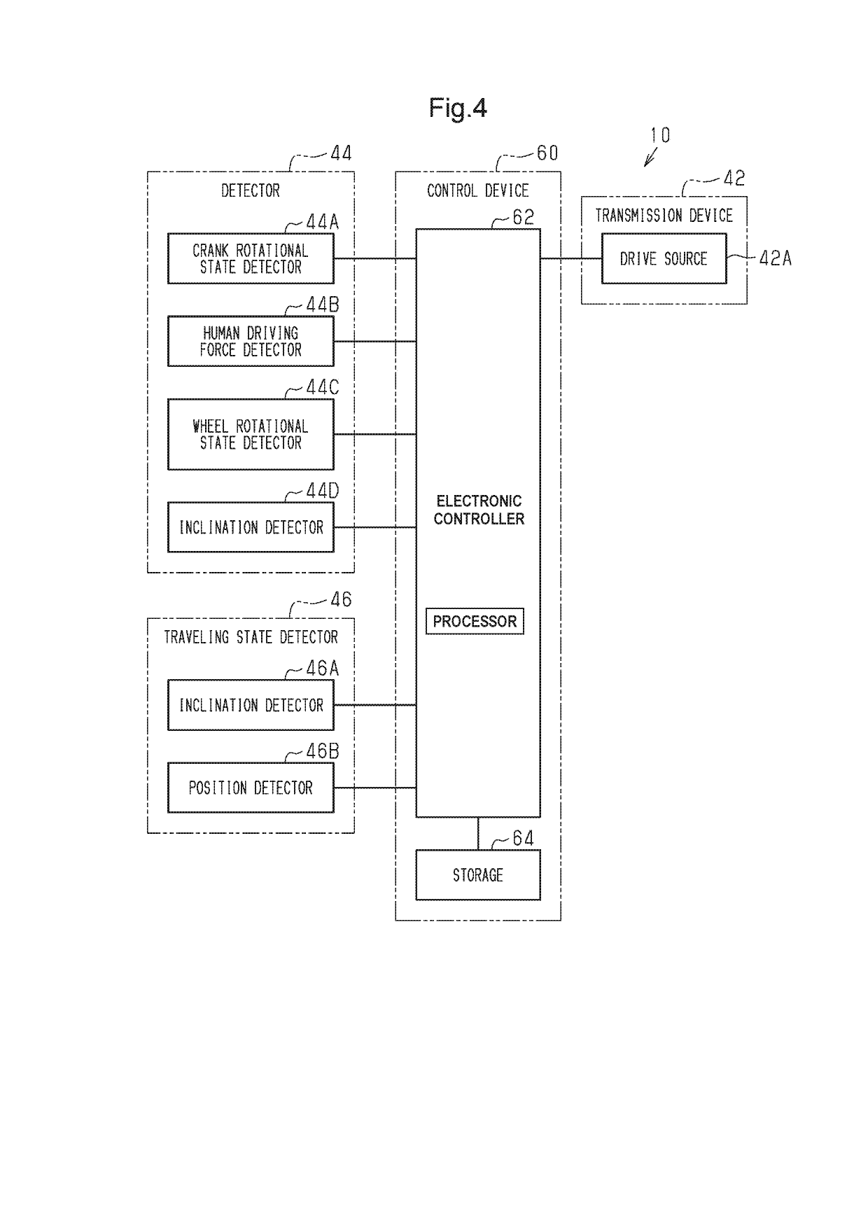

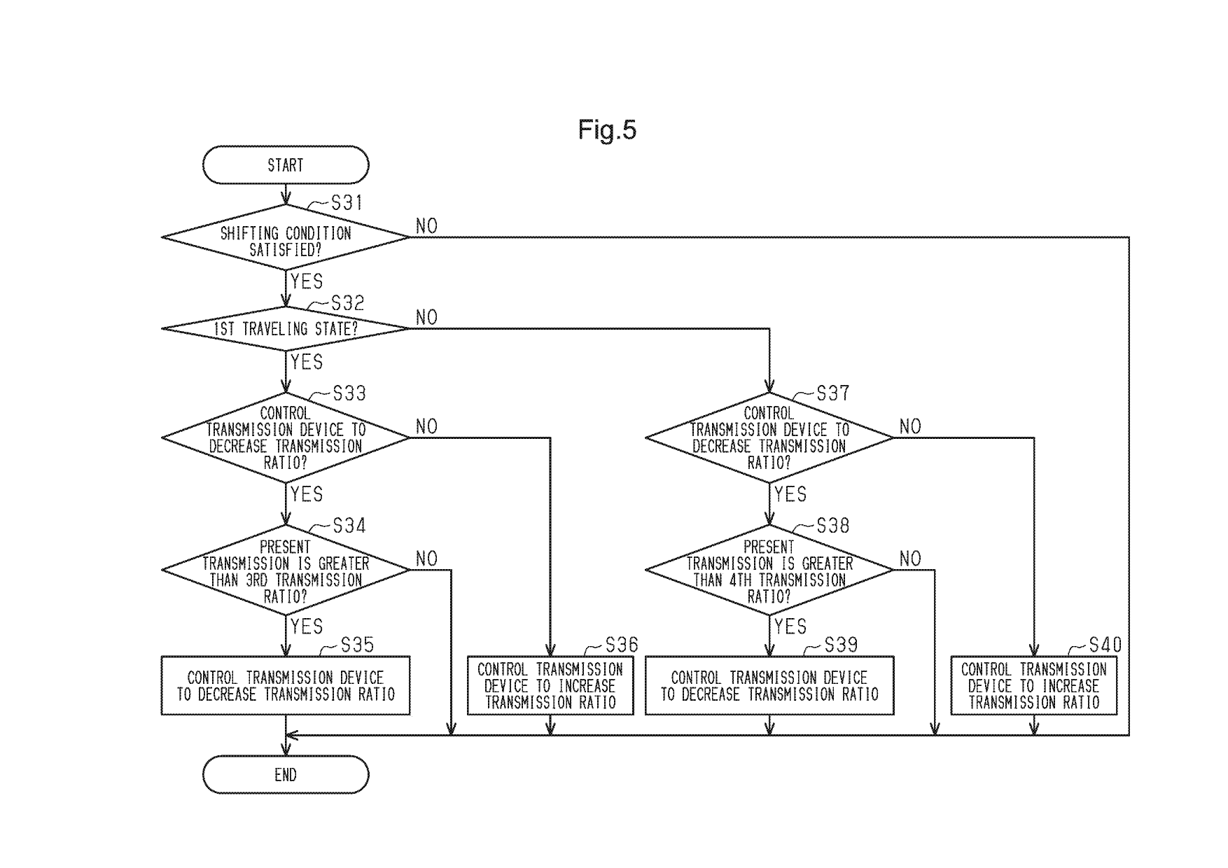

A human-powered vehicle control device 60 in accordance with a second embodiment will now be described with reference to FIGS. 4 and 5. Same reference numerals are given to those components of the human-powered vehicle control device 60 in the second embodiment that are the same as the corresponding components in the first embodiment. Such components will not be described in detail.

The electronic controller 62 of the present embodiment is configured to control the transmission device 42 in accordance with a traveling state of the human-powered vehicle 10. The traveling state is related to, for example, at least one of a gradient of a road on which the human-powered vehicle 10 is traveling and a vibration level of the human-powered vehicle 10.

The control system 40 includes, for example, a traveling state detector 46 that detects the traveling state. The traveling state detector 46 includes, for example, an inclination detector 46A. The inclination detector 46A is, for example, provided on the human-powered vehicle 10. For example, the inclination detector 46A has the same configuration as the inclination detector 44D.

Instead of or in addition to the inclination detector 46A, the traveling state detector 46 can include a position detector 46B. The position detector 46B includes, for example, a global positioning system (GPS) receiver. In a case where the position detector 46B includes a GPS receiver, for example, map information including information related to road gradient is stored in the storage 64 in advance. The electronic controller 62 acquires the road gradient of the present location of the human-powered vehicle 10 from the map information stored in the storage 64. The electronic controller 62 can acquire a road surface condition of the present location of the human-powered vehicle 10 from the map information stored in the storage 64. For example, the electronic controller 62 can be configured to calculate at least one of the vibration level of the human-powered vehicle 10 and a change rate of the vibration level based on the road surface condition of the present location of the human-powered vehicle 10.

In a case where the electronic controller 62 controls the transmission device 42 to decrease the transmission ratio based on the shifting condition and where the traveling state of the human-powered vehicle 10 is a first traveling state, the electronic controller 62 of the present embodiment is configured to control the transmission device 42 so that the transmission ratio does not become less than a third transmission ratio. In a case where the electronic controller 62 controls the transmission device 42 to decrease the transmission ratio based on the shifting condition and where the traveling state is a second traveling state differing from the first traveling state, the electronic controller 62 of the present embodiment is configured to control the transmission device 42 so that the transmission ratio does not become less than a fourth transmission ratio that is greater than the third transmission ratio.

In an example, the first traveling state and the second traveling state have a mutually exclusive relationship. The traveling state can include a traveling state other than the first traveling state and the second traveling state. The traveling state is related to, for example, at least one of the gradient of the road on which the human-powered vehicle 10 is traveling, a change rate of the gradient, the vibration level of the human-powered vehicle 10, and the change rate of the vibration level. For example, the first traveling state is greater than the second traveling state in at least one of the gradient of the road on which the human-powered vehicle 10 is traveling, the change rate of the gradient, the vibration level of the human-powered vehicle 10, and the change rate of the vibration level. The first traveling state includes, for example, a state in which the human-powered vehicle 10 is traveling off-road. The second traveling state includes, for example, a state in which the human-powered vehicle 10 is traveling on-road. In a state in which the human-powered vehicle 10 is traveling off-road, at least one of the gradient of the road on which the human-powered vehicle 10 is traveling, the change rate of the gradient, the vibration level of the human-powered vehicle 10, and the change rate of the vibration level is greater than that in a state in which the human-powered vehicle 10 is traveling on-road.

The electronic controller 62 is, for example, configured to select one of the third transmission ratio and the fourth transmission ratio in accordance with an output of the inclination detector 46A. In a case where the traveling state detector 46 includes the position detector 46B, the electronic controller 62 can be configured to select one of the third transmission ratio and the fourth transmission ratio based on the positional information of the human-powered vehicle 10. The electronic controller 62 selects the third transmission ratio, for example, in a case where at least one of the gradient of the road on which the human-powered vehicle 10 is traveling, the change rate of the gradient, the vibration level of the human-powered vehicle 10, and the change rate of the vibration level detected by the traveling state detector 46 corresponds to the first traveling state. The electronic controller 62 selects the fourth transmission ratio, for example, in a case where at least one of the gradient of the road on which the human-powered vehicle 10 is traveling, the change rate of the gradient, the vibration level of the human-powered vehicle 10, and the change rate of the vibration level detected by the traveling state detector 46 corresponds to the second traveling state.

A control process executed by the electronic controller 62 to control the transmission device 42 will now be described with reference to FIG. 5. In a case where electric power is supplied to the electronic controller 62, for example, the electronic controller 62 starts the control process of the flowchart shown in FIG. 5 from step S31. In a case where the control process of the flowchart shown in FIG. 5 ends, for example, the electronic controller 62 repeats the control process from step S31 in predetermined cycles until the supply of electric power is stopped.

In step S31, the electronic controller 62 determines whether the shifting condition is satisfied. The electronic controller 62 determines whether the shifting condition is satisfied, for example, based on a comparison result of the predetermined parameter and the threshold value. In a case where the predetermined parameter includes the lower limit threshold value and the upper limit threshold value, for example, the electronic controller 62 determines that the second shifting condition is satisfied in either one of a case where the predetermined parameter is less than the lower limit threshold value and a case where the predetermined parameter is greater than the upper limit threshold value. In a case where the shifting condition is not satisfied, the electronic controller 62 ends the control process. In a case where the shifting condition is satisfied, the electronic controller 62 proceeds to step S32.

In step S32, the electronic controller 62 determines whether the traveling state is the first traveling state. The electronic controller 62 determines that the traveling state is the first traveling state based on at least one of a case where an absolute value of the gradient of the road on which the human-powered vehicle 10 is traveling is greater than a predetermined gradient, the change rate of the gradient is greater than a predetermined gradient change rate, the vibration level of the human-powered vehicle 10 is greater than a predetermined vibration level, and the change rate of the vibration level is greater than a predetermined vibration level change rate. In a case where the traveling state is the first traveling state, the electronic controller 62 proceeds to step S33. In step S33, the electronic controller 62 determines whether to control the transmission device 42 to decrease the transmission ratio. The electronic controller 62 performs the determination in step S33, for example, based on the determination result of the predetermined parameter and the threshold value in step S31. The electronic controller 62 determines to control the transmission device 42 to decrease the transmission ratio, for example, in a case where the predetermined parameter is less than the lower limit threshold value. The electronic controller 62 determines not to control the transmission device 42 to decrease the transmission ratio, for example, in a case where the predetermined parameter is greater than the upper limit threshold value. In a case where the electronic controller 62 controls the transmission device 42 to decrease the transmission ratio, the electronic controller 62 proceeds to step S34.

In step S34, the electronic controller 62 determines whether the present transmission ratio is greater than the third transmission ratio. In a case where the present transmission ratio is greater than the third transmission ratio, the electronic controller 62 proceeds to step S35. In step S35, the electronic controller 62 controls the transmission device 42 to decrease the transmission ratio, and then ends the control process.

In a case where the present transmission ratio is not greater than the third transmission ratio in step S34, the electronic controller 62 ends the control process. In a case where the present transmission ratio is less than or equal to the third transmission ratio in step S34, for example, the electronic controller 62 does not change the transmission ratio from the present transmission ratio.

In a case where the electronic controller 62 determines not to control the transmission device 42 to decrease the transmission ratio in step S33, the electronic controller 62 proceeds to step S36. In step S36, the electronic controller 62 controls the transmission device 42 to increase the transmission ratio, and then ends the control process.

In a case where the traveling state is not the first traveling state in step S32, the electronic controller 62 proceeds to step S37. In the present embodiment, a case where the traveling state is not the first traveling state corresponds to a case where the traveling state is the second traveling state. In step S37, the electronic controller 62 determines whether to control the transmission device 42 to decrease the transmission ratio. The electronic controller 62 performs the determination in step S37, for example, based on the determination result of the predetermined parameter and the threshold value in step S31. The electronic controller 62 determines to control the transmission device 42 to decrease the transmission ratio, for example, in a case where the predetermined parameter is less than the lower limit threshold value. The electronic controller 62 determines not to control the transmission device 42 to decrease the transmission ratio, for example, in a case where the predetermined parameter is greater than the upper limit threshold value. In a case where the electronic controller 62 controls the transmission device 42 to decrease the transmission ratio, the electronic controller 62 proceeds to step S38.

In step S38, the electronic controller 62 determines whether the present transmission ratio is greater than the fourth transmission ratio. In a case where the present transmission ratio is greater than the fourth transmission ratio, the electronic controller 62 proceeds to step S39. In step S39, the electronic controller 62 controls the transmission device 42 to decrease the transmission ratio, and then ends the control process.

In a case where the present transmission ratio is not greater than the fourth transmission ratio in step S38, the electronic controller 62 ends the control process. In a case where the present transmission ratio is less than or equal to the fourth transmission ratio in step S38, for example, the electronic controller 62 does not change the transmission ratio from the present transmission ratio.

In a case where the electronic controller 62 determines not to control the transmission device 42 to decrease the transmission ratio in step S37, the electronic controller 62 proceeds to step S40. In step S40, the electronic controller 62 controls the transmission device 42 to increase the transmission ratio, and then ends the control process.

In a case where the shifting condition does not include the additional threshold value, steps S33, S36, S37, and S40 can be omitted. In a case where the shifting condition does not include the additional threshold value, and where an affirmative determination is given in step S32, the electronic controller 62 proceeds to step S34. In a case where the shifting condition does not include the additional threshold value, and where a negative determination is given in step S32, the electronic controller 62 proceeds to step S38.

### Third Embodiment

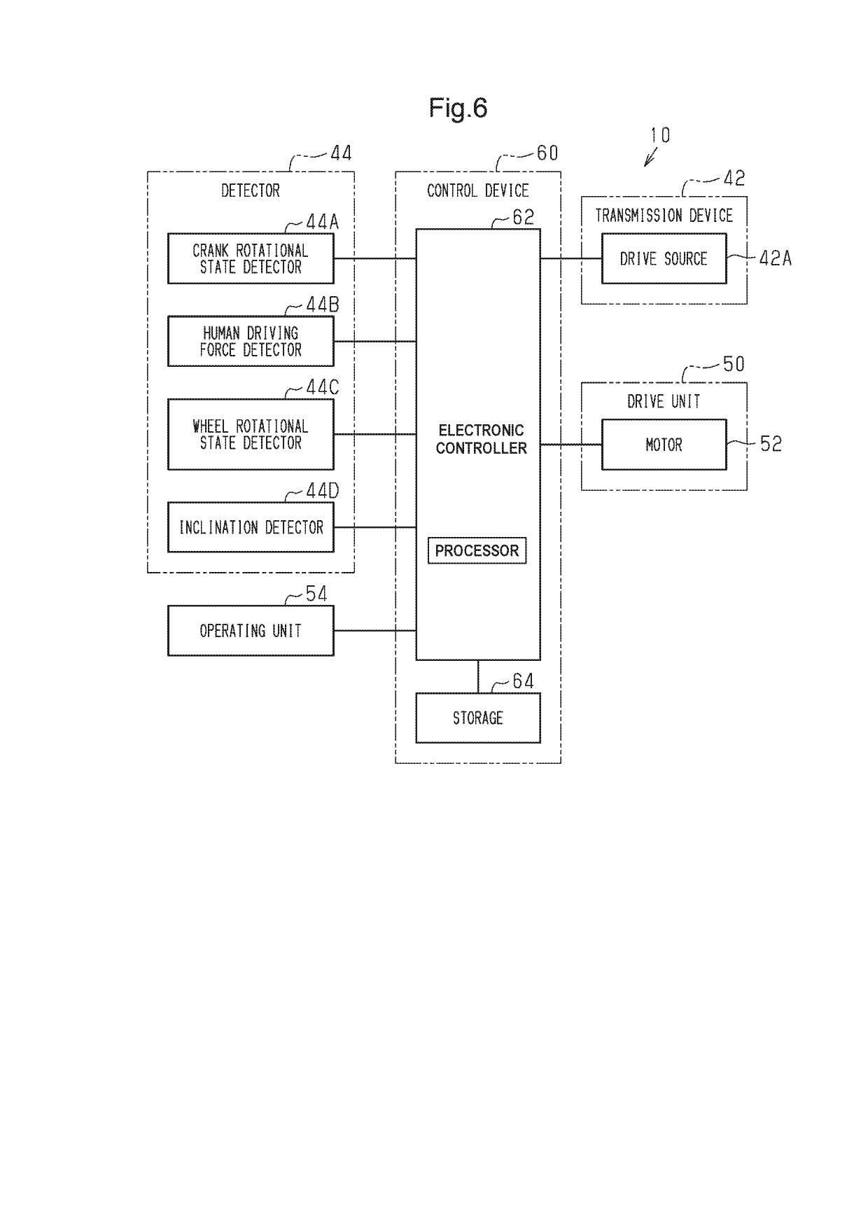

A human-powered vehicle control device 60 in accordance with a third embodiment will now be described with reference to FIGS. 1, 6, and 7. Same reference numerals are given to those components of the human-powered vehicle control device 60 in the third embodiment that are the same as the corresponding components in the first embodiment. Such components will not be described in detail.

The control system 40 includes, for example, a drive unit 50. The drive unit 50 includes, for example, a motor 52 configured to apply a propulsion force to the human-powered vehicle 10. The motor 52 is configured to drive the transferring member 38. The motor 52 is, for example, configured to apply a propulsion force to the human-powered vehicle 10 in accordance with the human driving force. The motor 52 includes, for example, one or more electric motors. The electric motor included in the motor 52 is, for example, a brushless motor. The motor 52 is, for example, configured to transmit rotational force to a power transmission path of the human driving force extending from the two pedals 24 to the at least one second rotational body 36. For example, the motor 52 drives the transferring member 38 via the at least one first rotational body 34. In the present embodiment, the motor 52 is provided on the frame 16 of the human-powered vehicle 10, and is configured to transmit rotational force to the first rotational body 34. The motor 52 can include a hub motor provided on the wheel 12.

The electronic controller 62 is, for example, configured to control the motor 52 to change an assist level of the motor 52. The electronic controller 62 is, for example, configured to control the motor 52 so that the assist level of the motor 52 is a predetermined assist level. The assist level includes, for example, at least one of a ratio of assist force of the motor 52 to the human driving force, an upper limit value of an output of the motor 52, and a response speed of the motor 52 to a change rate of the human driving force.

The assist force is, for example, expressed as at least one of torque and power. In a case where the assist force is expressed as torque, for example, the assist force is referred to as assist torque. In a case where the assist force is expressed as power, for example, the assist force is referred to as assist force-based power. The ratio of the assist force to the human driving force can be a ratio of the assist torque to the human torque or a ratio of the assist force-based power to the human force-based power.

The drive unit 50 includes, for example, a plurality of setting states. The setting states include, for example, a state related to an output level of the drive unit 50. For example, the output level in a first setting state is greater than the output level in a second setting state. The output level can correspond to the assist force. For example, the assist force in the first setting state is greater than the assist force in the second setting state. For example, the ratio of the assist force of the motor 52 to the human driving force in the first setting state is greater than the ratio of the assist force of the motor 52 to the human driving force in the second setting state. The first setting state can be a control state suitable for off-road. The second setting state can be a control state suitable for on-road.

The human-powered vehicle 10 further includes, for example, an operating unit 54 with which a user change the setting state. The operating unit 54 is, for example, provided on a portion of the human-powered vehicle 10 that can be operated by the user riding the human-powered vehicle 10. The operating unit 54 is, for example, provided on the handlebar 28. The operating unit 54 can also be referred to as a user operable input device. The term “user operable input device” refers to a device that allows users to operate another device. The operating unit or user operable input device 54 can include, for example, a button, a switch, a lever, a dial and/or a touch screen. The operating unit or user operable input device 54 can be mounted on a suitable portion of the human-powered vehicle 10 such as the handlebar 28 or the frame 16.

The electronic controller 62 is, for example, configured to acquire the setting state from at least one of the operating unit 54 and the drive unit 50. The electronic controller 62 acquires the setting information, for example, in response to an operation signal for changing the setting information transmitted from the operating unit 54.

The drive unit 50 is, for example, configured to change the setting state based on the traveling state of the human-powered vehicle 10. The electronic controller 62 is, for example, configured to acquire the setting state from the drive unit 50. The electronic controller 62 acquires the setting information, for example, from a drive unit controller provided on the drive unit 50.

In a case where the electronic controller 62 controls the transmission device 42 to decrease the transmission ratio based on the shifting condition and where the setting state of the drive unit 50 configured to apply a propulsion force to the human-powered vehicle 10 is the first setting state, the electronic controller 62 is configured to control the transmission device 42 so that the transmission ratio does not become less than a fifth transmission ratio. In a case where the electronic controller 62 controls the transmission device 42 to decrease the transmission ratio based on the shifting condition and where the setting state is the second setting state differing from the first setting state, the electronic controller 62 is configured to control the transmission device 42 so that the transmission ratio does not become less than a sixth transmission ratio that is greater than the fifth transmission ratio.

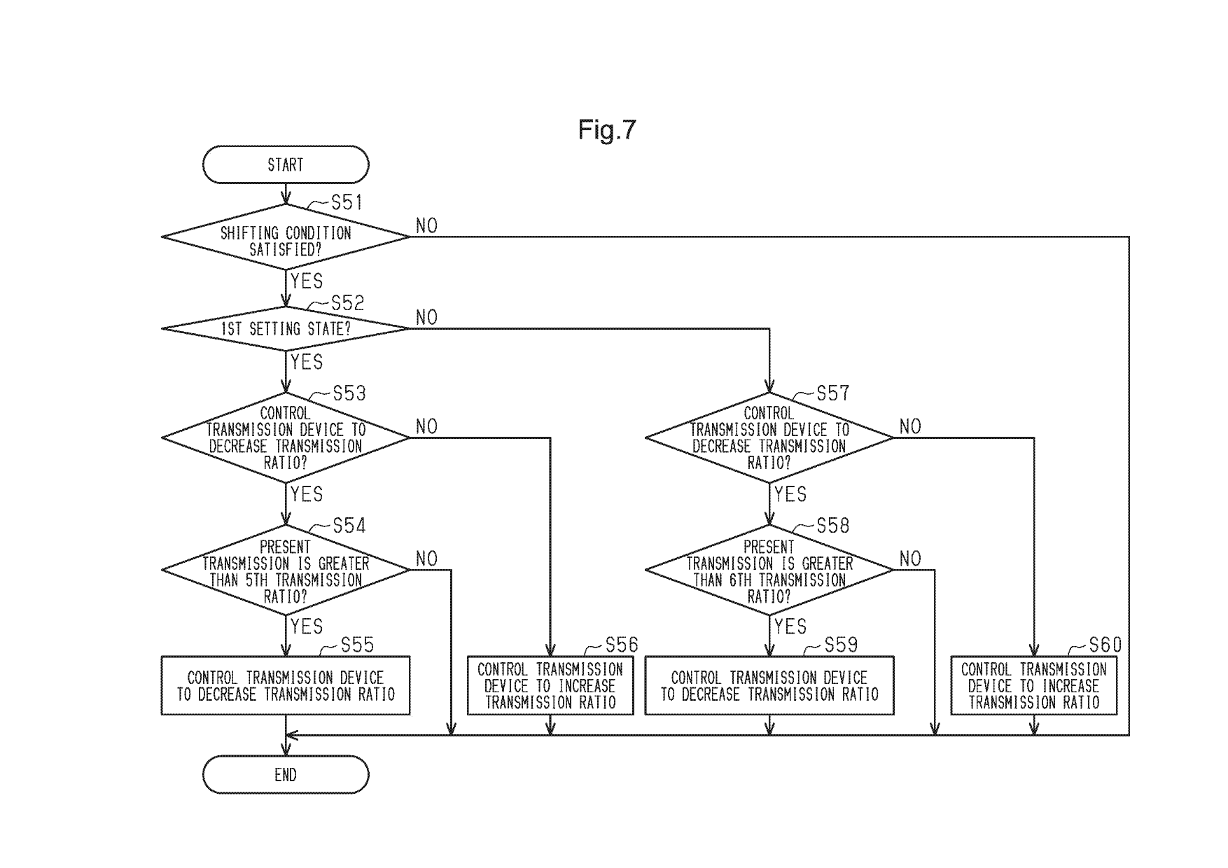

A control process executed by the electronic controller 62 to control the transmission device 42 will now be described with reference to FIG. 7. In a case where electric power is supplied to the electronic controller 62, for example, the electronic controller 62 starts the control process of the flowchart shown in FIG. 7 from step S51. In a case where the control process of the flowchart shown in FIG. 7 ends, for example, the electronic controller 62 repeats the control process from step S51 in predetermined cycles until the supply of electric power is stopped.

In step S51, the electronic controller 62 determines whether the shifting condition is satisfied. The electronic controller 62 determines whether the shifting condition is satisfied, for example, based on a comparison result of the predetermined parameter and the threshold value. In a case where the predetermined parameter includes the lower limit threshold value and the upper limit threshold value, for example, the electronic controller 62 determines that the second shifting condition is satisfied in either one of a case where the predetermined parameter is less than the lower limit threshold value and a case where the predetermined parameter is greater than the upper limit threshold value. In a case where the shifting condition is not satisfied, the electronic controller 62 ends the control process. In a case where the shifting condition is satisfied, the electronic controller 62 proceeds to step S52.

In step S52, the electronic controller 62 determines whether the setting state is the first setting state. In a case where the setting state is the first setting state, the electronic controller 62 proceeds to step S53. In step S53, the electronic controller 62 determines whether to control the transmission device 42 to decrease the transmission ratio. The electronic controller 62 performs the determination in step S53, for example, based on the determination result of the predetermined parameter and the threshold value in step S51. The electronic controller 62 determines to control the transmission device 42 to decrease the transmission ratio, for example, in a case where the predetermined parameter is less than the lower limit threshold value. The electronic controller 62 determines not to control the transmission device 42 to decrease the transmission ratio, for example, in a case where the predetermined parameter is greater than the upper limit threshold value. In a case where the electronic controller 62 controls the transmission device 42 to decrease the transmission ratio, the electronic controller 62 proceeds to step S54.

In step S54, the electronic controller 62 determines whether the present transmission ratio is greater than the fifth transmission ratio. In a case where the present transmission ratio is greater than the fifth transmission ratio, the electronic controller 62 proceeds to step S55. In step S55, the electronic controller 62 controls the transmission device 42 to decrease the transmission ratio, and then ends the control process.

In a case where the present transmission ratio is not greater than the fifth transmission ratio in step S54, the electronic controller 62 ends the control process. In a case where the present transmission ratio is less than or equal to the fifth transmission ratio in step S54, for example, the electronic controller 62 does not change the transmission ratio from the present transmission ratio.

In a case where the electronic controller 62 determines not to control the transmission device 42 to decrease the transmission ratio in step S53, the electronic controller 62 proceeds to step S56. In step S56, the electronic controller 62 controls the transmission device 42 to increase the transmission ratio, and then ends the control process.

In a case where the setting state is not the first setting state in step S52, the electronic controller 62 proceeds to step S57. In the present embodiment, a case where the setting state is not the first setting state corresponds to a case where the setting state is the second setting state. In step S57, the electronic controller 62 determines whether to control the transmission device 42 to decrease the transmission ratio. The electronic controller 62 performs the determination in step S57, for example, based on the determination result of the predetermined parameter and the threshold value in step S51. The electronic controller 62 determines to control the transmission device 42 to decrease the transmission ratio, for example, in a case where the predetermined parameter is less than the lower limit threshold value. The electronic controller 62 determines not to control the transmission device 42 to decrease the transmission ratio, for example, in a case where the predetermined parameter is greater than the upper limit threshold value. In a case where the electronic controller 62 controls the transmission device 42 to decrease the transmission ratio, the electronic controller 62 proceeds to step S58.

In step S58, the electronic controller 62 determines whether the present transmission ratio is greater than the sixth transmission ratio. In a case where the present transmission ratio is greater than the sixth transmission ratio, the electronic controller 62 proceeds to step S59. In step S59, the electronic controller 62 controls the transmission device 42 to decrease the transmission ratio, and then ends the control process.

In a case where the present transmission ratio is not greater than the sixth transmission ratio in step S58, the electronic controller 62 ends the control process. In a case where the present transmission ratio is less than or equal to the sixth transmission ratio in step S58, for example, the electronic controller 62 does not change the transmission ratio from the present transmission ratio.

In a case where the electronic controller 62 determines not to control the transmission device 42 to decrease the transmission ratio in step S57, the electronic controller 62 proceeds to step S60. In step S60, the electronic controller 62 controls the transmission device 42 to increase the transmission ratio, and then ends the control process.

In a case where the shifting condition does not include the additional threshold value, steps S53, S56, S57, and S60 can be omitted. In a case where the shifting condition does not include the additional threshold value and where an affirmative determination is given in step S52, the electronic controller 62 proceeds to step S54. In a case where the shifting condition does not include the additional threshold value and where a negative determination is given in step S52, the electronic controller 62 proceeds to step S58.

### Modified Examples

The description related with the above embodiments exemplifies, without any intention to limit, applicable forms of a human-powered vehicle control device. In addition to the embodiments described above, the human-powered vehicle control device according to the present disclosure is applicable to, for example, modified examples of the above embodiments that are described below and combinations of at least two of the modified examples that do not contradict each other. In the modified examples described hereafter, same reference numerals are given to those components that are the same as the corresponding components of the above embodiments. Such components will not be described in detail.

In the first embodiment, in a case where a shift operator is operated to decrease the transmission ratio in a state in which the first shifting condition is selected, the electronic controller 62 can control the transmission device 42 so that the transmission ratio becomes less than the first transmission ratio.

In the first embodiment, in a case where the shift operator is operated to decrease the transmission ratio in a state in which the second shifting condition is selected, the electronic controller 62 can control the transmission device 42 so that the transmission ratio becomes less than the second transmission ratio.

In the second embodiment, in a case where the shift operator is operated to decrease the transmission ratio in a state in which the traveling state is the first traveling state, the electronic controller 62 can control the transmission device 42 so that the transmission ratio becomes less than the third transmission ratio.

In the second embodiment, in a case where the shift operator is operated to decrease the transmission ratio in a state in which the traveling state is the second traveling state, the electronic controller 62 can control the transmission device 42 so that the transmission ratio becomes less than the fourth transmission ratio.

In the third embodiment, in a case where the shift operator is operated to decrease the transmission ratio in a state in which the setting state is the first setting state, the electronic controller 62 can control the transmission device 42 so that the transmission ratio becomes less than the fifth transmission ratio.

In the third embodiment, in a case where the shift operator is operated to decrease the transmission ratio in a state in which the setting state is the second setting state, the electronic controller 62 can control the transmission device 42 so that the transmission ratio becomes less than the sixth transmission ratio.

In the first embodiment, in a case where the first shifting condition is selected, the human-powered vehicle 10 is at a standstill, and the transmission ratio is less than the first transmission ratio, the electronic controller 62 can be configured to control the transmission device 42 so that the transmission ratio is not shifted to the first transmission ratio. In a case where the first shifting condition is selected, the human-powered vehicle 10 is at a standstill, the transmission ratio is less than the first transmission ratio, and the traveling road is an uphill road, the electronic controller 62 can be configured to control the transmission device 42 so that the transmission ratio is not shifted to the first transmission ratio. In a case where the first shifting condition is selected, the human-powered vehicle 10 is at a standstill, the transmission ratio is less than the first transmission ratio, and the traveling road is not an uphill road, the electronic controller 62 can be configured to control the transmission device 42 so that the transmission ratio is shifted to the first transmission ratio. In the present modified example, in a case where the transmission device 42 includes an internal transmission device, the electronic controller 62 can be configured to control the transmission device 42 so that the transmission ratio is shifted to the first transmission ratio while the human-powered vehicle 10 is at a standstill. In the present modified example, in a case where the transmission device 42 includes an external transmission device and the human-powered vehicle 10 includes the drive unit 50, the electronic controller 62 can be configured to control the transmission device 42 by driving the motor 52 so that the transmission ratio is shifted to the first transmission ratio while the human-powered vehicle 10 is at a standstill.

In the first embodiment, in a case where the second shifting condition is selected, the human-powered vehicle 10 is at a standstill, and the transmission ratio is less than the second transmission ratio, the electronic controller 62 can be configured to control the transmission device 42 so that the transmission ratio is not shifted to the second transmission ratio. In a case where the second shifting condition is selected, the human-powered vehicle 10 is at a standstill, the transmission ratio is less than the second transmission ratio, and the traveling road is an uphill road, the electronic controller 62 can be configured to control the transmission device 42 so that the transmission ratio is not shifted to the second transmission ratio. In a case where the second shifting condition is selected, the human-powered vehicle 10 is at a standstill, the transmission ratio is less than the second transmission ratio, and the traveling road is not an uphill road, the electronic controller 62 can be configured to control the transmission device 42 so that the transmission ratio is shifted to the second transmission ratio. In the present modified example, in a case where the transmission device 42 includes an internal transmission device, the electronic controller 62 can be configured to control the transmission device 42 so that the transmission ratio is shifted to the second transmission ratio while the human-powered vehicle 10 is at a standstill. In the present modified example, in a case where the transmission device 42 includes an external transmission device and the human-powered vehicle 10 includes the drive unit 50, the electronic controller 62 can be configured to control the transmission device 42 by driving the motor 52 so that the transmission ratio is shifted to the second transmission ratio while the human-powered vehicle 10 is at a standstill.

In the second embodiment, in a case where the traveling state is the first traveling state, the human-powered vehicle 10 is at a standstill, and the transmission ratio is less than the third transmission ratio, the electronic controller 62 can be configured to control the transmission device 42 so that the transmission ratio is not shifted to the third transmission ratio. In a case where the traveling state is the first traveling state, the human-powered vehicle 10 is at a standstill, the transmission ratio is less than the third transmission ratio, and the traveling road is an uphill road, the electronic controller 62 can be configured to control the transmission device 42 so that the transmission ratio is not shifted to the third transmission ratio. In a case where the traveling state is the first traveling state, the human-powered vehicle 10 is at a standstill, the transmission ratio is less than the third transmission ratio, and the traveling road is not an uphill road, the electronic controller 62 can be configured to control the transmission device 42 so that the transmission ratio is shifted to the third transmission ratio. In the present modified example, in a case where the transmission device 42 includes an internal transmission device, the electronic controller 62 can be configured to control the transmission device 42 so that the transmission ratio is shifted to the third transmission ratio while the human-powered vehicle 10 is at a standstill. In the present modified example, in a case where the transmission device 42 includes an external transmission device and the human-powered vehicle 10 includes the drive unit 50, the electronic controller 62 can be configured to control the transmission device 42 by driving the motor 52 so that the transmission ratio is shifted to the third transmission ratio while the human-powered vehicle 10 is at a standstill.

In the second embodiment, in a case where the traveling state is the second traveling state, the human-powered vehicle 10 is at a standstill, and the transmission ratio is less than the fourth transmission ratio, the electronic controller 62 can be configured to control the transmission device 42 so that the transmission ratio is not shifted to the fourth transmission ratio. In a case where the traveling state is the second traveling state, the human-powered vehicle 10 is at a standstill, the transmission ratio is less than the fourth transmission ratio, and the traveling road is an uphill road, the electronic controller 62 can be configured to control the transmission device 42 so that the transmission ratio is not shifted to the fourth transmission ratio. In a case where the traveling state is the second traveling state, the human-powered vehicle 10 is at a standstill, the transmission ratio is less than the fourth transmission ratio, and the traveling road is not an uphill road, the electronic controller 62 can be configured to control the transmission device 42 so that the transmission ratio is shifted to the fourth transmission ratio. In the present modified example, in a case where the transmission device 42 includes an internal transmission device, the electronic controller 62 can be configured to control the transmission device 42 so that the transmission ratio is shifted to the fourth transmission ratio while the human-powered vehicle 10 is at a standstill. In the present modified example, in a case where the transmission device 42 includes an external transmission device and the human-powered vehicle 10 includes the drive unit 50, the electronic controller 62 can be configured to control the transmission device 42 by driving the motor 52 so that the transmission ratio is shifted to the fourth transmission ratio while the human-powered vehicle 10 is at a standstill.

In the third embodiment, in a case where the setting state is the first setting state, the human-powered vehicle 10 is at a standstill, and the transmission ratio is less than the fifth transmission ratio, the electronic controller 62 can be configured to control the transmission device 42 so that the transmission ratio is not shifted to the fifth transmission ratio. In a case where the setting state is the first setting state, the human-powered vehicle 10 is at a standstill, the transmission ratio is less than the fifth transmission ratio, and the traveling road is an uphill road, the electronic controller 62 can be configured to control the transmission device 42 so that the transmission ratio is not shifted to the fifth transmission ratio. In a case where the setting state is the first setting state, the human-powered vehicle 10 is at a standstill, the transmission ratio is less than the fifth transmission ratio, and the traveling road is not an uphill road, the electronic controller 62 can be configured to control the transmission device 42 so that the transmission ratio is shifted to the fifth transmission ratio. In the present modified example, in a case where the transmission device 42 includes an internal transmission device, the electronic 62 can be configured to control the transmission device 42 so that the transmission ratio is shifted to the fifth transmission ratio while the human-powered vehicle 10 is at a standstill. In the present modified example, in a case where the transmission device 42 includes an external transmission device, the electronic controller 62 can be configured to control the transmission device 42 by driving the motor 52 so that the transmission ratio is shifted to the fifth transmission ratio while the human-powered vehicle 10 is at a standstill.

In the third embodiment, in a case where the setting state is the second setting state, the human-powered vehicle 10 is at a standstill, and the transmission ratio is less than the sixth transmission ratio, the electronic controller 62 can be configured to control the transmission device 42 so that the transmission ratio is not shifted to the sixth transmission ratio. In a case where the setting state is the second setting state, the human-powered vehicle 10 is at a standstill, the transmission ratio is less than the sixth transmission ratio, and the traveling road is an uphill road, the electronic controller 62 can be configured to control the transmission device 42 so that the transmission ratio is not shifted to the sixth transmission ratio. In a case where the setting state is the second setting state, the human-powered vehicle 10 is at a standstill, the transmission ratio is less than the sixth transmission ratio, and the traveling road is not an uphill road, the electronic controller 62 can be configured to control the transmission device 42 so that the transmission ratio is shifted to the sixth transmission ratio. In the present modified example, in a case where the transmission device 42 includes an internal transmission device, the electronic controller 62 can be configured to control the transmission device 42 so that the transmission ratio is shifted to the sixth transmission ratio while the human-powered vehicle 10 is at a standstill. In the present modified example, in a case where the transmission device 42 includes an external transmission device, the electronic controller 62 can be configured to control the transmission device 42 by driving the motor 52 so that the transmission ratio is shifted to the sixth transmission ratio while the human-powered vehicle 10 is at a standstill.

In the first embodiment, the electronic controller 62 can be configured to select one of the shifting conditions based on at least one of a transmission ratio obtainable by a front transmission device, a transmission ratio obtainable by a rear transmission device, the type of the human-powered vehicle 10, the width of a tire of the human-powered vehicle 10, and the circumferential length of a tire of the human-powered vehicle 10.

In the third embodiment, the electronic controller 62 can be configured to select one of the fifth transmission ratio and the sixth transmission ratio, instead of or in addition to the setting state of the drive unit 50, based on at least one of a transmission ratio obtainable by a front transmission device, a transmission ratio obtainable by a rear transmission device, the type of the human-powered vehicle 10, the width of a tire of the human-powered vehicle 10, and the circumferential length of a tire of the human-powered vehicle 10.

In each embodiment, the shifting condition can further include a condition in which the human-powered vehicle 10 is decelerating. The condition in which the human-powered vehicle 10 is decelerating is satisfied, for example, in a case where the acceleration of the human-powered vehicle 10 is continuously less than or equal to a predetermined acceleration over a predetermined period or longer. In this modified example, the shifting condition includes the threshold value and does not have to include the additional threshold value. In a case where the transmission device 42 is controlled to shift the transmission ratio while the human-powered vehicle 10 is decelerating and before the human-powered vehicle 10 stops, the rider can resume traveling on the human-powered vehicle 10 at a preferred transmission ratio.

In this specification, the phrase “at least one of” as used in this disclosure means “one or more” of a desired choice. As one example, the phrase “at least one of” as used in this disclosure means “only one single choice” or “both of two choices” if the number of its choices is two. As another example, the phrase “at least one of” as used in this disclosure means “only one single choice” or “any combination of two or more choices” if the number of its choices is three or more. Also, the term “and/or” as used in this disclosure means “either one of or both of.” For instance, the phrase “at least one of A and B” encompasses (1) A alone, (2) B alone, and (3) both A and B. The phrase “at least one of A, B, and C” encompasses (1) A alone, (2) B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Ordinal numerals such as “first”, “second”, and “third” are used in this disclosure only to distinguish members having the same name from one another and are not intended to have any special meaning.

What is claimed is:

1. A control device for a human-powered vehicle, the control device comprising:
an electronic controller configured to control a transmission device for shifting a transmission ratio that is a ratio of a rotational speed of a wheel of the human-powered vehicle to a rotational speed of a crank axle of the human-powered vehicle,
the electronic controller being configured to control the transmission device to shift the transmission ratio based on one of a plurality of shifting conditions,
the shifting conditions include a first shifting condition and a second shifting condition differing from the first shifting condition,
in a case where the electronic controller controls the transmission device to decrease the transmission ratio based on the first shifting condition, the electronic controller is configured to control the transmission device so that the transmission ratio does not become less than a first transmission ratio that is greater than a minimum transmission ratio,
the minimum transmission ratio being a smallest transmission ratio to which the transmission device can be shifted, and
in a case where the electronic controller controls the transmission device to decrease the transmission ratio based on the second shifting condition, the electronic controller being configured to control the transmission device so that the transmission ratio does not become less than a second transmission ratio that is greater than the first transmission ratio.

2. The control device according to claim 1, wherein
the first shifting condition includes a first threshold value related to a predetermined parameter,
the second shifting condition includes a second threshold value related to the predetermined parameter and differing from the first threshold value,
in a case where the electronic controller controls the transmission device to shift the transmission ratio based on the first shifting condition, the electronic controller is configured to control the transmission device to decrease the transmission ratio where the predetermined parameter crosses the first threshold value and so that the transmission ratio does not become less than the first transmission ratio, and
in a case where the electronic controller controls the transmission device to shift the transmission ratio based on the second shifting condition, the electronic controller is configured to control the transmission device to decrease the transmission ratio where the predetermined parameter crosses the second threshold value and so that the transmission ratio does not become less than the second transmission ratio.

3. The control device according to claim 2, wherein
the second threshold value is less than the first threshold value,
in a case where the electronic controller controls the transmission device to shift the transmission ratio based on the first shifting condition, the electronic controller is configured to control the transmission device to decrease the transmission ratio where the predetermined parameter becomes less than the first threshold value and so that the transmission ratio does not become less than the first transmission ratio, and
in a case where the electronic controller controls the transmission device to shift the transmission ratio based on the second shifting condition, the electronic controller is configured to control the transmission device to decrease the transmission ratio where the predetermined parameter becomes less than the second threshold value and so that the transmission ratio does not become less than the second transmission ratio.

4. A control device for a human-powered vehicle, the control device comprising:
an electronic controller configured to control a transmission device for shifting a transmission ratio that is a ratio of a rotational speed of a wheel of the human-powered vehicle to a rotational speed of a crank axle of the human-powered vehicle,
the electronic controller being configured to control the transmission device to shift the transmission ratio based on a shifting condition,
in a case where the electronic controller controls the transmission device to decrease the transmission ratio based on the shifting condition and where a traveling state of the human-powered vehicle is a first traveling state, the electronic controller being configured to control the transmission device so that the transmission ratio does not become less than a third transmission ratio,
in a case where the electronic controller controls the transmission device to decrease the transmission ratio based on the shifting condition and where the traveling state of the human-powered vehicle is a second traveling state differing from the first traveling state, the electronic controller being configured to control the transmission device so that the transmission ratio does not become less than a fourth transmission ratio that is greater than the third transmission ratio.

5. The control device according to claim 4, wherein
the first traveling state is greater than the second traveling state in at least one of a gradient of a road on which the human-powered vehicle is traveling, a change rate of the gradient, a vibration level of the human-powered vehicle, and a change rate of the vibration level.

6. The control device according to claim 5, wherein
the electronic controller is configured to select one of the third transmission ratio and the fourth transmission ratio in accordance with an output of an inclination detector provided on the human-powered vehicle.

7. The control device according to claim 4, wherein
the first traveling state includes a state in which the human-powered vehicle is traveling off-road, and
the second traveling state includes a state in which the human-powered vehicle is traveling on-road.

8. The control device according to claim 7, wherein
the electronic controller is configured to select one of the third transmission ratio and the fourth transmission ratio based on positional information of the human-powered vehicle.

9. The control device according to claim 4, wherein
the shifting condition includes a threshold value related to a predetermined parameter, and
in a case where the electronic controller controls the transmission device to shift the transmission ratio based on the shifting condition, the electronic controller is configured to control the transmission device to decrease the transmission ratio where the predetermined parameter crosses the threshold value.

10. The control device according to claim 9, wherein
in a case where the electronic controller controls the transmission device to shift the transmission ratio based on the shifting condition, the electronic controller is configured to control the transmission device to decrease the transmission ratio where the predetermined parameter becomes less than the threshold value.

11. A control device for a human-powered vehicle, the control device comprising:
an electronic controller configured to control a transmission device for shifting a transmission ratio that is a ratio of a rotational speed of a wheel of the human-powered vehicle to a rotational speed of a crank axle of the human-powered vehicle,
the electronic controller is configured to control the transmission device to shift the transmission ratio based on a shifting condition,
in a case where the electronic controller controls the transmission device to decrease the transmission ratio based on the shifting condition and where a setting state of a drive unit configured to apply a propulsion force to the human-powered vehicle is a first setting state, the electronic controller being configured to control the transmission device so that the transmission ratio does not become less than a fifth transmission ratio, and
in a case where the electronic controller controls the transmission device to decrease the transmission ratio based on the shifting condition and where the setting state is a second setting state differing from the first setting state, the electronic controller being configured to control the transmission device so that the transmission ratio does not become less than a sixth transmission ratio that is greater than the fifth transmission ratio.

12. The control device according to claim 11, wherein
the setting state includes a state related to an output level of the drive unit, and
the output level in the first setting state is greater than the output level in the second setting state.

13. The control device according to claim 12, wherein
the human-powered vehicle further includes an operating unit with which a user changes the setting state, and
the electronic controller is configured to acquire the setting state from at least one of the operating unit and the drive unit.

14. The control device according to claim 12, wherein
the drive unit is configured to change the setting state based on a traveling state of the human-powered vehicle, and
the electronic controller is configured to acquire the setting state from the drive unit.

15. The control device according to claim 14, wherein
the shifting condition includes a threshold value related to a predetermined parameter, and
in a case where the electronic controller controls the transmission device to shift the transmission ratio based on the shifting condition, the electronic controller is configured to control the transmission device to decrease the transmission ratio where the predetermined parameter crosses the threshold value.

16. The control device according to claim 15, wherein
in a case where the electronic controller controls the transmission device to shift the transmission ratio based on the shifting condition, the electronic controller is configured to control the transmission device to decrease the transmission ratio where the predetermined parameter becomes less than the threshold value.

17. The control device according to claim 2, wherein
the predetermined parameter is related to the rotational speed of the crank axle.

18. The control device according to claim 2, wherein
the predetermined parameter is related to a human driving force applied to the crank axle.
